(19) United States
(12) Patent Application Publication
(10) Pub. No.: US 2026/0149470 A1
(43) Pub. Date: May 28, 2026

(54) LOW POWER BEAMFORMING

(71) Applicant: Beyond Semiconductor, d.o.o., Ljubljana-Crnuce (SI)

(72) Inventors: Drago Strle, Ljubljana (SI); Matjaž Breskvar, Ljubljana (SI)

(21) Appl. No.: 19/401,039

(22) Filed: Nov. 25, 2025

Related U.S. Application Data
(60) Provisional application No. 63/724,943, filed on Nov. 26, 2024.

(51) Int. Cl. H04B 1/00; H04B 1/04; H04B 1/10; H04B 7/0426

(52) U.S. Cl. CPC H04B 1/0003; H04B 1/0475; H04B 1/10; H04B 7/043

(57) ABSTRACT

Systems and methods for scalable digital beamforming and low power analog amplification are provided. Various embodiments of the present technology provide systems and methods for achieving efficient data distribution and superior signal integrity in multi-chip sensor arrays. Embodiments of the digital beamforming architecture utilizes a plurality of chiplets where sampled analog-to-digital converter bitstreams are distributed wirelessly via low power short-range transmitters in an inherently broadcast manner, thereby achieving scalable interconnectivity complexity. Embodiments include a system and method that uses a multi-stage, multi-path feed-forward compensated operational amplifier configured with a non-idealities reduction loop that employs chopping to frequency-translate and suppress low-frequency non-idealities, such as flicker noise and offset voltage, enabling power-efficient data conversion circuitry like continuous-time sigma delta ADCs.

### CROSS-REFERENCE TO RELATED APPLICATION(S)

This application claims a benefit of priority under 35 U.S.C. § 119 (e) from U.S. Provisional Application No. 63/724,943, filed Nov. 26, 2024, entitled LOW POWER BEAMFORMING,” which is fully incorporated by reference herein, including all appendices, for all purposes.

### TECHNICAL FIELD

This disclosure relates generally to low power beamforming and signal processing. In particular, this disclosure relates to systems and methods for scalable digital beamforming that provides reduced power consumption through wireless distribution of sampled signals. Even more specifically, this disclosure relates to compensated multi-stage operational amplifier architectures designed to suppress low-frequency non-idealities, enabling power-efficient circuits like sigma delta analog-to-digital converters.

### BACKGROUND

This disclosure relates generally to digital beamforming and high-performance analog circuitry, particularly low power operational amplifiers. Conventional digital beamforming systems struggle with power consumption and scalability when integrating many antenna elements, often resulting in complex and power-hungry inter-chip wiring that scales quadratically with the number of connections. Separately, achieving power-efficient operation in CMOS circuits, such as those used in continuous-time sigma delta analog-to-digital converters, is limited by high flicker noise at low frequencies and the tendency of non-idealities (VNI) from the first gain stage to reduce the signal-to-noise ratio (SNR). Current noise reduction techniques often increase the overall power consumption or bandwidth requirement of the amplifier. Therefore, there is a clear need for improved, scalable, and power-efficient architectural solutions for both data distribution in beamforming systems and non-ideality reduction in analog amplification stages.

### SUMMARY

Systems are described that provide a distributed beamforming solution utilizing multiple chiplets. This system collectively includes several analog-to-digital converters (ADCs) for sampling antenna signals, digital beamforming logic (DBFL), a plurality of low power wireless short-range transmitters (WTXs) configured to broadcast a digital bitstream corresponding to the sampled signals, and a plurality of low power wireless short-range receivers (WRXs) configured to receive broadcast digital bitstreams from other chiplets. The ADCs and the DBFL are distributed across the plurality of chiplets, the sampled ADC bitstreams are distributed between the chiplets wirelessly, and the DBFL is configured to compute beamformed channels using at least the wirelessly received digital bitstreams from other chiplets.

In some embodiments, systems are described that provide a multi-stage, multi-path feed-forward (MSMPFF) compensated operational amplifier configured to reduce non-idealities. The MSMPFF amplifier includes a main signal path having a first main gain stage transconductor designed to amplify an input signal. A first chopper is placed before the input of the first main gain stage transconductor and is configured to frequency-translate the input signal into a higher frequency band. A de-chopper is located after an output of the first main gain stage transconductor and is configured to translate the amplified signal back toward a baseband frequency. Furthermore, a non-idealities reduction loop (NRL) is included to suppress non-ideality remains. The NRL consists of a non-idealities extraction circuit (NEC) that senses non-ideality remains present in the main signal path, a feedback transconductor that generates a compensating current proportional to the sensed non-ideality remains, and a current combining node configured to sum the compensating current with an output current of the first main gain stage transconductor to cancel or reduce the non-idealities.

In some embodiments, methods are described for distributed beamforming within a system having a plurality of chiplets. The method comprises sampling antenna signals using a plurality of ADCs and distributing the sampled signals by broadcasting the resulting digital bitstream through a plurality of low power WTXs, wherein this broadcasting is performed in an inherently broadcast manner such that a signal from one WTX may be received by any number of chiplets within range. The method also involves receiving the broadcast digital bitstreams from other chiplets via a plurality of low power WRXs and computing beamformed channels using DBFL. Both the ADCs and the DBFL are distributed across the plurality of chiplets, and the computing step utilizes at least the wirelessly received digital bitstreams from other chiplets.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE FIGURES

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 shows a model of a basic structure of a multi-stage, multi-path feed-forward operational amplifier including input-referred noise sources and offset voltages.

FIGS. 2-5 illustrate various embodiments for applying chopping and non-ideality reduction circuits to operational amplifier structures to suppress non-idealities.

FIG. 6 shows an example circuit implementation of one embodiment of amplifier chopping.

FIG. 6a shows a variation of the amplifier implementation shown in FIG. 6, where a voltage amplifier controls the body bias terminals of the first main gain stage transconductor.

FIG. 7 shows signal diagrams in the frequency domain at various nodes of the multi-stage operational amplifier shown in FIG. 2.

FIG. 8 illustrates an embodiment of a non-idealities extraction circuit comprising a high pass filter, a chopper, and a low pass filter, along with corresponding signal diagrams.

FIG. 9 shows an alternative embodiment of an non-idealities extraction circuit utilizing a fully differential switched capacitor circuit.

FIG. 10 shows an embodiment of a transistor-level realization of a differential chopper circuit.

FIG. 11 shows an alternative simplified non-idealities extraction circuit.

FIG. 12 shows an embodiment of a distributed low power scalable digital beamformer comprising separate analog-to-digital converter chips and digital beamforming logic chips.

FIG. 13 shows a single die scalable digital beamforming solution integrating analog-to-digital converter channels and digital beamforming logic.

FIG. 14 shows an embodiment of how multiple single die beamforming solutions may be combined to form a scalable distributed beamforming system.

### DETAILED DESCRIPTION

The invention and the various features and advantageous details thereof are explained more fully with reference to the nonlimiting embodiments that are illustrated in the accompanying drawings and detailed in the following description as included in the Appendix. Descriptions of well known starting materials, processing techniques, components and equipment are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure.

### Problem Description and Solutions

Electromagnetic frequency bands are increasingly congested, limiting the performance of communication and sensing systems. One option is to use of higher frequency bands which offer more bandwidth but at expense of propagation properties (distance of information sending) and cost.

Beamforming is another possibility which on transmit side emits (majority) of energy in the desired direction and on the receive side focuses sensing of the energy originating from specific direction. This is how multiple wireless connections can be formed in different directions and on the same frequency band, increasing the data throughput a frequency band can support. Besides increasing the data transfer rates in limited spectrum (important in e.g. WiFi, 5G, etc.), digital beamforming is key technology that can be leveraged to achieve low probability of intercept (LPI) and low probability of detection (LPD) radars and military communications. Beamforming is also effective countermeasure against jamming.

Fully digital beamforming enables maximum flexibility and best performance. However, it often isn't feasible due to increased power consumption due to multiplication of complete receive and transmit chains.

Embodiments described herein focus on reducing power consumption of RF filters, signal data transfer buses and data converters including ADC's (analog to digital converters) and DAC's (digital to analog converters), all of which are usual components of (digital) beamforming solutions. The reduced power consumption enables usage of beamforming where it would not be possible otherwise or usage of more sophisticated beamforming resulting in improved SNR, better data throughput, higher resilience and in general better performance characteristics of communication and sensing solutions.

The key component that often determine the performance and power consumption of RF N-path filters, sigma delta (SD) ADC's and many other analogue (including RF-) circuits is the opamp. One insight is that RF signals can be converted to low frequencies where they can be sampled/manipulated more efficiently. Furthermore, when the N-path SD ADC are constructed as disclosed, for example, in commonly-owned U.S. Patent Application Pub. No. 2024/0187019 A1, entitled “HIGH FREQUENCY, LOW POWER, N-PATH SIGMA-DELTA MODULATOR,” filed on Oct. 25, 2023 (which is incorporated herein by reference in its entirety for all purposes), it effectively transforms a band pass SD modulator to a low pass sigma delta modulator, that is more efficient due to needing only low pass filtering (as opposed to band-pass filtering comprising of low pass filtering and high pass filtering). Thus, sampling close to DC can be very beneficial. However, the power efficient chip manufacturing technologies (e.g., Si CMOS) exhibit high flicker noise at low frequencies degrading the performance characteristics (e.g., SNR) of receive and transmit chains. In order to address this novel high performance opamp architectures are disclosed. In addition to usage as part of sigma delta modulators (for analog to digital as well as digital to analog conversion) it may be used to realize the N-path RF filters and other analogue circuits.

On the reception side the filtered and digitalized RF signals from multiple receive chains may need to be transmitted to digital beamforming logic where appropriate mathematical transformations are performed to obtain distinct beamformed receive channels corresponding to reception from distinct directions. Similar is the concept of nulling where appropriate mathematical transformations are performed to obtain high level of suppression of signals received from distinct directions. Hereafter both of these applications including other applications where streams of data from different sources need to be combined to (i.e. perform mathematical transformations to achieve beamforming, nulling, synthetic aperture, etc.)

Each beamformed receive channel is computed from multiple real signal bitstreams captured on different antennae in the array. This means that bitstreams from distinct ADC's need to be transferred to the same digital beamforming logic block. This is manageable in single die (chip) realization (as on-chip data buses are relatively efficient) but may require that the single chip implements all the need ADC's. This may quickly become unfeasible, as ADC's occupy non-trivial area and consume significant power. Also, such monolith die solutions are not scale-able, often suffer yield and cost issues and still may limit possible on-die signal routing. A possible approach is to use multiple discrete ADC chips and transfer all the digitalized signal data to a separate and distinct beamforming chip. In such case the beamforming chip requires large number of IO ports and interconnect wires between the chips are quickly problematic (and very power hungry). Again, the solution is not scalable as the beamforming chip needs to be design with a set number of IO pins (connections).

A distributed approach comprises a chip with one or more ADC's and digital beamforming logic. In such case, each chip needs to be connected with all the other chips which ADC's would contribute to beamformed receive channel. While scalable, the wiring between such chips may quickly become very complicated and power hungry. To avoid this, the ADC received bitstream is transmitted via short-range high-speed wireless link and can thus be received by many chips within range. With such architecture, the power consumption required for data transfer between chiplets stays constant—it doesn't matter how many chiplets receive the signal as long as they are all in range. Thus, each chiplet can implement a beamforming logic with limited number of beamformed channels, while complete solution can easily scale up to more beamformed channels by simply adding additional chiplets. In some embodiments, these chiplets are all the same (one mask set, one, design) and do not need any wired connection between them. The sampled ADC bitstreams are distributed between chiplets wirelessly in inherently broadcast manner. This avoids the need for many chip pins, and complex PCB connections.

The disclosed approach is also valuable in case of single die chips to address on-die routing congestion. In case of N data sources and M data sinks, the required number of wires to achieve full connectivity scales quadratically (N. M). On the other hand, the number of required receivers and transmitters for full connectivity scales only linearly with the number of data sources and data sinks (N+M). This is because wireless transmissions are by nature broadcasting (one to many).

### Low Power Digital Beamforming

On the reception side, it is possible and may be beneficial to construct (compute) more beams than there are physical antennae. The receive beamforming is essentially spatial (directional) filtering of received signals. Furthermore, the received SNR (Signal to Noise Ratio) improves with increased number of antennae.

Digital beamforming is computationally demanding and thus power hungry. The characteristics of the beams (1289, . . . 1299) as computed by the digital beamforming logic (DBFL) (1287, . . . , 1297) can be better (narrower, higher gain, better SNR, more selective spatial filtering) the more signals from antennae elements (1211, 1221, 1231) the beams (1289, . . . 1299) are computed from. Thus, if possible, it makes sense to maximize the number of antennae elements signals to enter into DBFL computations. To route the wires from each antenna element ADC (1213, 1223, . . . , 1233) to the DBFL gets increasingly difficult when number of antenna elements increases and when the number of distinct DBFL blocks increases. The required number of wires increases quadratically with increase in number of antenna elements and/or DBFLs. For example, in case of 100 antenna elements each connected to own ADC and 50 DBFLs all computing the beams taking into account signals from all antenna elements, there needs to be a data connection from each ADC to each DBFL block. Thus, 100 connections (usually with multiple wires) from ADC to each of the 50 DBFL blocks resulting in 5000 connections (with multiple wires). Contrast this with one wireless transmitter per each ADC (1217, 1227, . . . , 1237) and one wireless receiver per each DFBL (1281, . . . , 1291) resulting in 100 wireless transmitters+50 wireless transceivers. As long as all wireless receivers are sufficiently close to be able to receive signals from all of the wireless transmitters there is no power increase on the wireless transmitters side when additional receivers are added. This is not the case with physical wires.

The described architecture for low power beamforming has scalability advantages as adding receivers (and additional DFBLs and thus additional beams) may result in no power increase of wireless transmissions. It has further scalability advantages as it enables flexible partitioning of functionality per chip (e.g. one or multiple ADC's on single chip, DBFL chips with different number of beams, chips with some ADC's and DBFL, etc.). Such flexibilities may be leveraged for optimization of cost, yield, chip area, power consumption and complexity of printed circuit boards & assembly. For example, DBFL may be sized in a way that the number of inputs and outputs (IO's) is such that the there is no or just little wasted space due to chip being heavily pad limited or logic/core limited. Additional beams, when needed can be obtained by using additional DBFL chips. As a further example, yields may be optimized due to smaller die size and ability to mix and match number of ADC channels per chip, number of DFBL chips and number of beams per DFBL chips. Furthermore, single chip with a number of ADCs and DFBL beams may be designed and thus simplify manufacturing, logistics, etc.

The invention may also enable simplification of the printed circuit boards, substrates or multi-chip modules by avoiding the need for large numbers of wired connections between ADC's and DFBL's. Planar nature of printed circuit boards and substrates places topological limits on number of possible connections and geometries of chip placements due to limited number routing layers, signal integrity issues, etc. Wireless connections with e.g. on-die integrated antennae enable much more flexible and thus optimal beamforming modules.

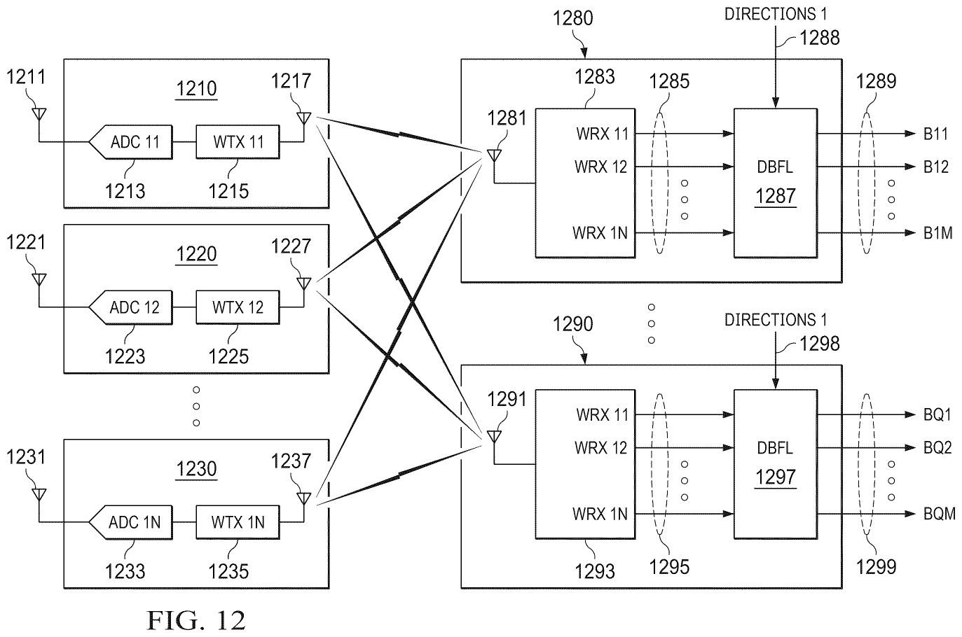

As shown in FIG. 12, a possible realization of distributed low power scalable digital beamformer comprises:
N instances of ADC chips (1210, 1220, . . . , 1230) with external antenna signal connections (1211, 1221, . . . , 1231), analog to digital converters (1213, 1223, . . . , 1233), wireless transmitters (1215, 1225, . . . , 1235) and wireless transmit antenna (1217, 1227, . . . , 1237).
The antenna signal (1211, 1221, . . . , 1231) is connected to the input of ADC (1213, 1223, . . . , 1233). The output of ADC (1213, 1223, . . . , 1233) is connected to the input of the wireless transmitter (1215, 1225, . . . 1235) which finally connects to wireless antenna (1217, 1227, . . . , 1237). It may be beneficial that wireless transmitter (1215, 1225, . . . , 1235) modulates signals on its input to high frequencies where plenty of bandwidth is available and enabling very compact antennae dimensions. In some cases, it may be also beneficial that the wireless transmission antennae (1217, 1227, . . . 1237) are implemented on same die, while in other cases it may be beneficial that the transmit antennae (1217, 1227, . . . , 1237) are implemented off-die.
The output of wireless transmitters is emitted (1217, 1227, . . . 1237) into space. The wireless receive antennae (1281, . . . , 1291) of chips (1280, 1290) in range receive the signal and pass it to wireless receivers (1283, 1293). The wireless receivers (1283, . . . , 1293) may comprise of circuits (WRX11, WRX12, . . . , WRX1N) enabling reception of distinct channels, e.g. from different ADC chips (1210, 1220, . . . , 1230). The wireless receivers (1283, . . . , 1293 circuits (WRX11, WRX12, . . . , WRX1N) may be demodulators or other digital radio circuits. Their realization and tradeoffs will be known to one skilled in the art.
The data digitalized by ADC (1213, 1223, . . . , 1233), may thus be output (1285, . . . , 1295) from wireless receivers (1283, . . . , 1293) to the inputs of the DBFL's (1287, . . . , 1297). Each DBFL (1287, . . . , 1297) may implement circuits for digital beam forming computations and it may have an additional input (1288, . . . , 1298) where parameters of desired beams may be configured such as e.g. beam direction, which beamforming algorithm to use, which inputs to take into account when computing beams, etc. Some embodiments may not have distinct input (1288, . . . , 1298).
The DBFL (1287, . . . , 1297) outputs (1289, . . . , 1299) may be used to output bitstreams representing distinct beams, e.g. pointing towards different direction.

Operation of distributed low power scalable digital beamformer:
The signal received on antenna (1211, 1221 . . . , 1231) is digitalized (1213, 1223, 1233), modulated (1215, 1225, . . . , 1235) and emitted (1217, 1227, . . . , 1237) into space.
The wireless antennae (1281, . . . , 1291) receive the emitted (1217, 1227, . . . , 1237) signals and demodulate (1283, 1293) them. The modulation (1215, 1225, 1235) and demodulation (1283, . . . , 1293) may be designed taking into account various power, cost, range, complexity, etc. trade-offs, as one skilled in the art would understand. Key property of special emissions (1217, 1227, . . . , 1237) is that they have broadcasting nature. Thus, signal from transmit antenna (1217, 1227, . . . , 1237) may be received by any number of receive antennae (1281, . . . , 1291) and receivers (1283, . . . , 1293) as long as they are in range.
The received signals (1281, . . . , 1291) are demodulated (1283, . . . , 1293) and passed (1285, . . . , 1295) to DBFL (1287, . . . , 1297). DBFL (1287, . . . , 1297) computes beams (1289, . . . , 1299) possibly taking into account requested configuration (1288, . . . , 1298). The algorithms for computing beams will be apparent to one skilled in the art. In some embodiments the DBFL (1287, . . . , 1297) may take into account requested beam directions (1288, . . . 1298) and other beam parameters as may be input (1288, . . . , 1298) to DFBL (1287, . . . , 1297). Other embodiments may, for example, compute beams with predetermined direction, etc.

Possible realizations of DBFL will be well understood by one skilled in the art. In one approach it is required to apply an appropriate time delay to each of the antenna signal. These time delays define the direction of the spatial filtering. In case of e.g. spatial scanning, it is understood that larger number of beams is beneficial, as each of the beams can search through the part of the spatial angles. Scanning can thus be performed in parallel—each of the beams direction may be independently adjusted.

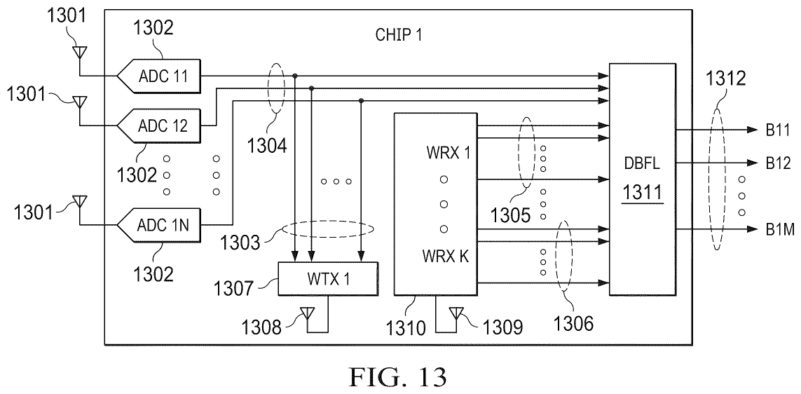

FIG. 13 shows a single die scalable digital beamforming solution integrating N ADC channels and M beamformed outputs.

The characteristics of the beams (1312) as computed by the digital beamforming logic (DBFL) (1311) may be better (narrower, higher gain, better SNR, more selective spatial filtering) the more signals from antennae elements (1301) the beams (1312) are computed from. Thus, if possible, it may be beneficial to maximize the number of antennae elements signals entering into DBFL computations.

The resulting beams (1312) represent the spatially filtered signals. The beams may be electronically steered by DBFL.

Even if DBFL for distinct beams is partitioned over multiple chips it may still be necessary to deliver all the antennae sampled signals to all of the DBFL instances. For example, let each of the chips have 8 receive channels connected to 8 antennae elements, and have each chip implement DBFL supporting 4 beams. Four such chips would support 16 beams computed out of signals from 32 antennae elements. To achieve this however, a very complicated wiring would be needed—the data from 8 receive channels (1302) needs to be supplied to the DBFL (1311) of the first chip—through on-die connections and in addition distributed to DBFL's of the other chips. In addition, data from 24 receive channels of the other chips needs to be supplied to the DBFL (1311) of the first chip. The required point-to-point connections between the chips can quickly become overwhelming, power hungry and not realistically implementable.

The problem may be solved by broadcasting the sample data sampled on one chip to the other chips. The samples (1302) received on first chip are in addition to being sent by on die wires (1304) to DBFL (1311) also sent by on-die wires (1303) to the low power wireless short-range transmitter (WTX) (1307) which modulates the signals to high frequencies and transmits them through on-die antenna (1308). The signals received from antennae on the other chips are also wirelessly transmitted by those chips so that they can be received by the first chip antenna (1309) and demodulated by the low power wireless short-range receiver (WRX2-WRXK) (1310). Such received signals sampled by ADC's of the other chips are then supplied to DBFL (1311) of the first chip to enable computation of beams (1312).

Since applications may be very different it may be beneficial to have a single die solution that may be scaled up by simply adding additional chips.

Such single die scalable beamforming solution comprises:
N instances of ADC channels (1302) that receive input signal from antenna elements (1301).
The outputs of ADC's (1302) are connected through on chip connections (1303) to wireless transmitter (1307) and through additional set of connection (1304) to DBFL (11).
The output of wireless transmitter (1307) is connected to a transmit antenna (1308) which may be on chip or off chip. The wireless transmitter (1307) and transmit antenna (1308) may be optimized for high bandwidth short distance connections.
The wireless receive antenna (1309) may be on die or off die. The wireless receive antenna (1309) is connected to wireless receiver (1310). The outputs (1305, 1306) of wireless receiver (1310) are connected to DBFL (1311).
The DBFL (1311) inputs (1304, 1305, 1306) are the (i) digital bitstreams (1304) output by on die ADC's (1302) and (ii) digital bitstreams (1305, 1306) output from the wireless receiver (1310).
The DBFL (1311) may perform the necessary computations and outputs (1312) the M computed beams.

Operation of single side scalable beamforming solution, such as that shown in FIG. 13:
The signals received by antennae (1301) are digitalized by ADC's (1302). The ADC's (1302) output a digital bitstreams that are (i) inputs (1303) to wireless transmitter (1307) and (ii) inputs (1304) to DBFL (1311).
The wireless transmitter (1307) may modulate the received signals and output (1303) them to wireless transmit antenna (1308). One skilled in the art will understand the tradeoffs and possible implementations of such wireless transmitter (1307).
The wireless receiver (1310) may demodulate the received signals and output (1305, 1306) them to DFBL (1311). One skilled in the art will understand the tradeoffs and possible implementations of such wireless receiver (1310).
The wireless receiver (1310) may be designed in a way that reception of signals from multiple wireless transmitters implemented on other chips may be possible. One skilled in the art will understand the tradeoffs and possible implementations of wireless communication systems such that appropriate modulation (may be implemented in wireless transmitter), appropriate demodulation (may be implemented in wireless receiver) and other technics for transmitting and receiving data over wireless channels.
The wireless transmitter (1307) may transmit synchronization information such that wireless receiver (1310) can synchronize with the wireless transmitter (1307) especially when wireless transmitter (1307) and wireless receiver (1310) are on separate chips.
DBFL (1311) receives data from ADC's (1302) implemented on same chip via inputs (1304). DBFL (1311) also receives data from ADC's implemented on different chips via inputs (1305, 1306) which are the outputs of wireless receiver (1310). DBFL (1311) may also receive any synchronization information received by wireless receiver (1310).
DBFL (1311) computes the digital beams (1312) from the data received from on-die ADC's (1302) and off-die ADC's. DBFL (1311) may perform digital beamforming algorithms. Other algorithms where combining (or taking into account) data from multiple ADC's is beneficial may also be used (e.g. nulling, MIMO, etc., . . . ). The possible implementations of DBFL (1311) are going to be well understood by one skilled in the art.

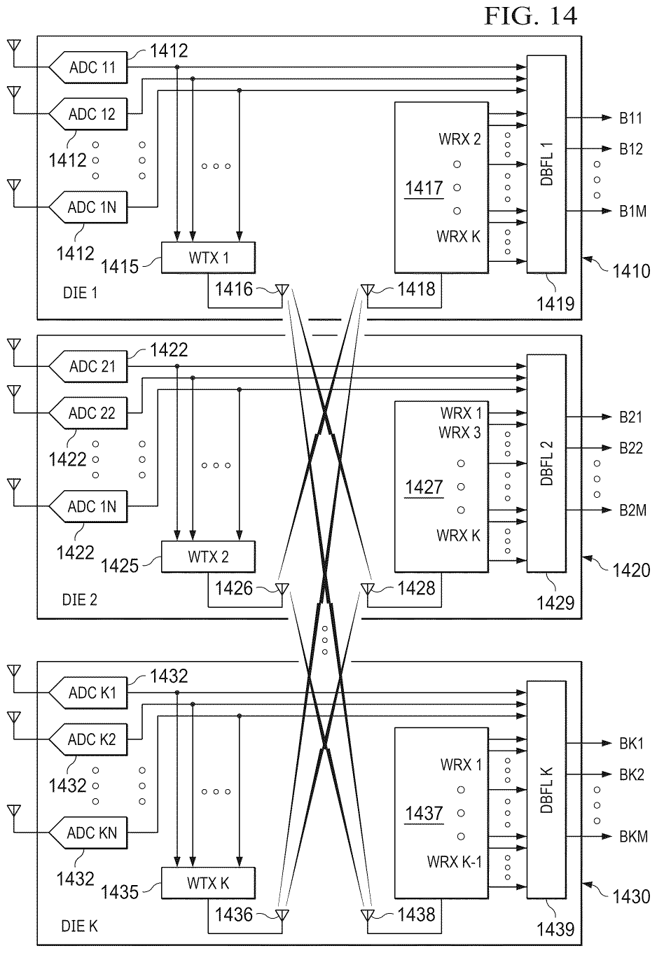

FIG. 14: shows how multiple chips as described in FIG. 13 may be combined to form a scalable distributed beamforming system.

The scalable distributed beamforming system comprises:
Multiple beamforming chips (1410, 1420, . . . , 1430). These may be such as previously shown in the FIG. 13. The beamforming chips (1410, 1420, . . . 1430) may be connected via wireless links between them. Depending on application not all beamforming chips may be connected through wireless links.
Each of the beamforming chips (1410, 1420, . . . , 1430) comprises of elements as described previously. Shown is realization with component described in FIG. 13, however, also embodiments with other combination of ADC's, wireless transmitters, wireless receivers, antennae and DBFL are possible and part of the invention. Some embodiments may use distinct ADC chips and DBFL chips (as shown in FIG. 12).
Depending on application, trade-offs and other constraints not all of the wireless receivers (1417, 1427, . . . , 1437) may be able to receive signals from all of the transmitters (1415, 1425, . . . 1435) in the system.

One embodiment of the scalable distributed beamforming system, such as that shown in FIG. 14, operates as follows:
The signals from ADC's (1412, 1422, . . . , 1432) may be modulated (or otherwise prepared for wireless transmission) by wireless transmitters (1415, 1425, . . . , 1435) and transmitted on wireless antennae (1416, 1426, . . . , 1436).
The data is broadcast from each transmit antennae (1416, 1426, . . . , 1436). Any wireless receiver (1417, 1427, . . . , 1437) with antenna (1418, 1428, . . . , 1438) in range may receive and demodulate (or otherwise decode) the received data. For example, the transmission from second chip (1420) may be received on some or all of the chips (1410, 1420 . . . , 1430). The wireless transmission from transmitter to receiver on the same chip may not be required.
The data received on antennae (1418, 1428, . . . , 1438) may be demodulated by wireless receivers (1417, 1427, . . . , 1437).
The data from on-die ADC's (1412, 1422, . . . , 1432) and the data received from ADC's on other dies (1412, 1422, . . . , 1432) may be an input to DFBL's (1419, 1429, . . . , 1439). For example, the data from on-die ADCs (1422) is passed to DFBL (1429) through on-die connections. The data from off-die ADC's (1412, . . . , 1432) is received by wireless receiver (1427) and passed to DBFL (1429).
The DBFL's (1419, 1429, . . . , 1439) may combine all received data to compute digital beams.

One key power consumption contributors of digital beamforming solutions is analog to digital conversion. The invention discloses how to reduce the power consumption of the opamp, which is one of the main power contributing components in many required analogue RF circuits and especially in sigma delta ADC's.

### Review of Solutions and Chopping in Multi-Stage Feed-Forward Compensated Amplifiers

For wide band amplifiers, ADC's, DAC's, NPath filters etc., the speed and power are determined on one side by the speed of the intrinsic NMOS and PMOS transistors and on the other by parasitic capacitances associated with silicon implementation. The smallest and fastest transistors are those with low threshold voltage and low supply voltage. Since the scaling of threshold voltage is not proportional to the supply voltage reduction, it becomes difficult, if not impossible, to use different versions of cascode architectures of the opamp to obtain sufficient amplification at low frequency and at the same time high bandwidth, which is needed for example, for appropriate operation of the high-speed ADC. As a result, it is necessary to use different architectures. For example, opamps used in continuous time ZA modulators typically need to have several cascaded stages, which usually makes phase compensation difficult. In addition, reducing the supply voltage requires a reduction of the signal level, which leads to reduced SNR if noise is not reduced.

A possible solution for the opamp implementation with high gain and high frequency without using casode devices, is to use well-known multi-stage amplifier with nested Muller compensation; the architecture has relatively low gain and requires large area and quite large current for HF operation. Better architecture is a Multi-Stage, Multi-path structure that is Feed-Forward compensated (MSMPFF).

It is known that the offset voltage and 1/f noise and other non-idealities (hereafter referred to as “non-idealities” or “VNI”, where VNI=V_{offset}+V_{1f}+V_{other-non-idealities}) of the opamps used in LP continuous-time ΣΔ modulator (LPCT ΣΔ) are mainly determined by the properties of the first integrator, while contributions of the following integrators to the output noise are less important because they are attenuated by corresponding intermediate signal transfer functions (ISTF) and intermediate noise transfer functions (INTF) of each integrator in the ZA loop. Non-idealities (VNI) of the first integrator enter the loop of the modulator unattenuated, like a signal and thus reduces the SNR. Therefore, the non-idealities of the first integrator need to be attenuated or moved to another band that is out of the baseband. That is exactly what is usually done in low-frequency high high-precision ΣΔ ADCs.

Two well-known techniques used for the attenuation of the VNI of the amplifier are correlated-double-sampling (CDS), used in SC (switched capacitor) circuits, and chopping (CHP), which is more appropriate for mixed continuous-time/discrete-time circuits. The main advantage of the chopping technique, if applied correctly, is a very small increase in thermal noise in the baseband, and removal of VNI from the band of interest, moving it to some other band; the VNIs are up modulated and filtered out. This process is acceptable if the band of interest is at low frequencies. However, for large bands and high frequencies, the frequency of chopping becomes very high, which increases power consumption. This technique is usually used in two stage folded-casode amplifiers, where the signal is chopped with a frequency that is several times larger than the highest frequency of the band of interest. Such an amplifier with chopping consumes a lot of power because it needs to be much faster than one without chopping. In addition, the VNIs are transferred to the high frequency around f_{chp}, and its multiples, where the spectral components can be quite big (amplified VNI) which reduces the useful dynamic range of the amplifier. This remains can be attenuated by a high-order LP filter or better, by so-called Ripple Reduction Loop (RRL).

It is possible to use chopping techniques as for the cascode amplifier, but then the power consumption would be higher than necessary because of higher bandwidth required of the whole amplifier including chopping operation. How to remove the VNI from the base-band of a feed forward multi-stage cascade amplifier without increasing power consumption too much is the idea disclosed in this disclosure.

### Multi-Stage, Multi-Path Feed-Forward Amplifier (MSMPFF Opamp) Architecture

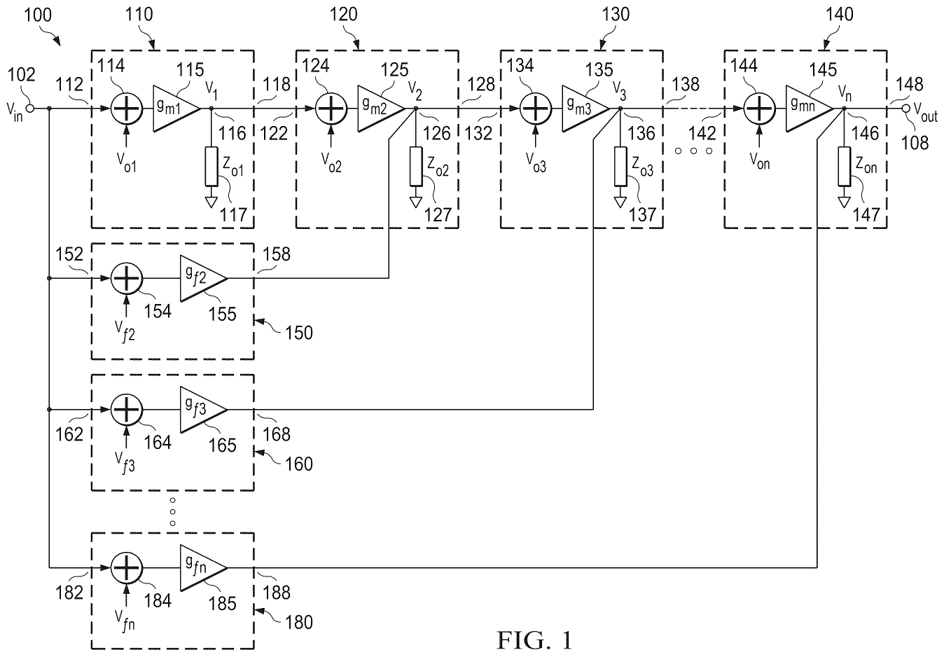

One embodiment of a model of a basic structure of the Multi-Stage, Multi-Path Feed-Forward compensated (MSMPFF) amplifier is presented in FIG. 1. Generally, the opamp includes n main path transconductance elements modelled by gₘᵢ (i=1 . . . n), n loads Zₒᵢ, and (n−1) feed-forward transconductors g_{fk} (k=2, . . . n). Each transconductor (gₓᵢ, x=m, f, . . . ) generates output current. Unfortunately, each transconductor also generates noise and offset voltage that is represented as an input-referred voltage source Vₒᵢ (i=1, . . . n) for main transconductors and V_{fi} (i=2, . . . n) for feed-forward transconductors. The Vₒᵢ and V_{fi} are composed of an offset voltage V_{offi} and 1/f noise with well-known power spectral density V_{nd(1/f)i}(ω) so that Vₒᵢ(ω)=V_{ooffi}+V_{ond(1/f)i}(ω) and V_{fi}(ω)=V_{foffi}+V_{fnd(1/f)i}(ω). The model of the basic structure of the MSMPFF opamp, including all Vₒᵢ and V_{fi} is presented in FIG. 1. FIG. 1 shows a model of the basic structure of a Multi-Stage, Multi-path Feed-Forward (MSMPFF) opamp amplifier including input-referred noise sources and offset voltages at the input of each transconductance element.

If Vₒᵢ's and V_{fi}'s, are neglected for the moment, the design procedure consists of appropriately selecting transconductance elements gₘᵢ, g_{fi}, and impedances Zₒᵢ in such a way that the resultant amplifier has required gain at low frequency given in formula (1), and appropriate single pole transfer function. The example transfer function for the 3rd order amplifier is given in (2).

$${H}_{0} = {\prod }_{i = 1}^{n} {g}_{mi} {r}_{oi} + {g}_{f 2} {\prod }_{i = 2}^{n} {g}_{mi} {r}_{oi} + {g}_{f 2} + ⋯ + {g}_{fn} {g}_{mn} {r}_{on} \qquad ( 1 )$$

$$H ( s ) = {H}_{0} \frac{( 1 + \frac{s}{{ω}_{Z 1}} ) ( 1 + \frac{s}{{ω}_{Z 2}} )}{( 1 + \frac{s}{{ω}_{p 1}} ) ( 1 + \frac{s}{{ω}_{p 2}} ) ( 1 + \frac{s}{{ω}_{p 3}} )} = {H}_{0} \frac{1}{( 1 + \frac{s}{{ω}_{p 1}} )} , \qquad ( 2 )$$

Where rₒᵢ (i=1, . . . ) is the real part of the corresponding impedance Zₒᵢ=rₒᵢ∥jωCₒᵢ. By selecting element values for gₘᵢ, g_{fi} and Zₒᵢ, the behavior of a single pole amplifier can be synthesized, which makes sure that the amplifier has enough bandwidth, high gain and adequate phase response even at different loads when it is used as an amplifier with the feedback. The resulting amplifier has a transfer function given by (2) if corresponding poles and zeros are cancelled; for example, if ω_{z1}=ωₚ₂, ω_{z2}=ωₚ₃, the ideal final transfer function contains only one pole; this can be achieved by appropriate selection of elements in the circuit using optimization procedure. The amplifier gets high gain at low frequency with relatively low dominant pole frequency. Additional bandwidth and thus high frequency of operation is enabled by adding additional transconductors gₘᵢ and g_{fi}, which must have appropriate pole frequencies and appropriate gain. The fastest feedthrough comes from the transconductor g_{fn}.

When analyzing the contributions of individual Vₒᵢ and V_{fi} sources to the output, it can be easily seen that the most important and the largest component comes from the first transconductor gₘ₁. The output voltage as a function of input voltage and all Vₒᵢ and V_{fi} contributions is given in (3).

$${V}_{out} = {V}_{in} \{ {\prod }_{i = 1}^{n} {g}_{mi} {r}_{oi} + {g}_{f 2} {\prod }_{i = 2}^{n} {g}_{mi} {r}_{oi} + {g}_{f 2} + ⋯ + {g}_{fn} {g}_{mn} {r}_{on} \} + \qquad ( 3 )$$

$$+ {V}_{o 1} {\prod }_{i = 1}^{n} {g}_{mi} {r}_{oi} + {V}_{o 2} {\prod }_{i = 2}^{n} {g}_{mi} {r}_{oi} + … + {V}_{on} {g}_{mn} {r}_{on} +$$

$$+ {V}_{f 2} {g}_{f 2} {\prod }_{i = 2}^{n} {g}_{mi} {r}_{oi} + {V}_{f 3} {g}_{f 3} {\prod }_{i = 3}^{n} {g}_{mi} {r}_{oi} + ⋯ + {V}_{fn} {g}_{fn} {r}_{on}$$

The biggest contribution comes from Vₒ₁, then from Vₒ₂ and V_{f2}, and so on. The differences to other contributors are gain factors obtained by the product of the following transconductors gₘᵢrₒᵢ. The second largest contributions come from gₘ₂ and g_{f2}, and so on.

FIG. 1 shows basic structure of the Multi-Stage, Multi-Path Feed-Forward (MSMPFF) compensated operational amplifier. It comprises multiple (shown are n) main path transconductance elements gₘᵢ with their loads and feed-forward transconductors g_{fi}. Their primary function is to output signal Vₒᵤₜ (108) that corresponds to amplified signal presented on input Vᵢₙ (102). Specifically, MSMPFF amplifier comprises:
Input port Vᵢₙ (102) may be connected to the input of the first main gain stage (110) and in parallel to inputs of multiple feed-forward gain stages, specifically to the input of first feed-forward gain stage (150) with transconductance g_{f2}, to the input of the second feed-forward gain stage (160) with transconductance g_{f3}, . . . and to the input of the last feed-forward gain stage (180) with transconductance g_{fn}. The number of feed-forward stages may or may not correspond to number of main gain stages.
The first main gain stage (110) output (118) is connected to the input (122) of the second main gain stage (120). The second main gain stage (120) output (128) is connected to the input (132) of the third main gain stage, and so on till the last (n-th) main gain stage (140) with input (142) of the n-th main gain stage (140) connected to the output of preceding main gain stage and its output (148) is connected to the output (108) of MSMPFF (100).
The first feed-forward gain stage (150) output is connected to the second main gain stage (120) load (127) at the same point (126) where the second main gain stage (120) transconductor (125) output is connected to the same load (127).
The second feed-forward gain stage (160) output is connected to the third main gain stage (130) load (137) at the same point (136) where the third main gain stage (130) transconductor (135) output is connected to the same load (137).
The last feed-forward gain stage (180) output is connected to the last main gain stage (140) load (147) at the same point (146) where the last main gain stage (140) transconductor (145) output is connected to the same load (147).
Each of the main gain stages (110, 120, 130, . . . , 140) comprises of its respective input port (112, 122, 132, . . . , 142) connected to its respective input inferred noise and offset voltage (Vₒ₁, Vₒ₂, Vₒ₃, . . . Vₒₙ) inputs added (114, 124, 134, . . . , 144) to the input of its respective transconductor (115, 125, 135, . . . , 145) with its output connected to the load (117, 127, 137, . . . 147). The additions (114, 124, 134, . . . , 144) may not be explicitly implemented and may be implicit by inner operation of transistors and other circuit elements of transconductor (115, 125, 135, . . . , 145) and other downstream elements (e.g. 117, 127, 137, . . . , 147, wires etc.). The additions (114, 124, 134, . . . , 144) may also be explicitly implemented (e.g. to inject additional signals, e.g. dithering, pseudo random signals, etc.) in which case the input inferred noise and offset voltage are considered lumped in the same input.
Each of the feed-forward gain stages (150, 160, . . . , 180) comprises of its respective input port (152, 162, . . . , 182) connected to its respective input inferred noise and offset voltage (V_{f2}, V_{f3}, . . . . V_{fn}) inputs added (154, 164, . . . , 184) to the input of its respective transconductor (155, 165, . . . , 185) with its output connected to the load (127, 137, . . . 147). The additions (154, 164, . . . , 184) may not be explicitly implemented and may be implicit by inner operation of transistors and other circuit elements of transconductor (155, 165, . . . , 185) and other downstream elements (e.g. 127, 137, . . . , 147, wires etc.). The additions (154, 164, . . . , 184) may also be explicitly implemented (e.g. to inject additional signals, e.g. dithering, pseudo random signals, etc.) in which case the input inferred noise and offset voltage are considered lumped in the same input.
Input port Vᵢₙ (102) is connected to the input (112) of first main gain stage (110) which is connected to first main gain stage transconductor (115) with transconductance (gₘ₁) and noise and voltage offset (V₀₁) represented (modeled) as input inferred noise and offset voltage (V₀₁) that is added (114) to the input of the transconductor (115). The addition (114) may not be explicitly implemented and may be implicit (caused) by inner operation of transistors and other circuit elements of transconductor (115) and other elements (e.g. 117, wires, etc.). The addition (114) may also be explicitly implemented (e.g. to inject additional signals, e.g. dithering, pseudo random signals, etc.) in which case the input inferred noise and offset voltage are considered lumped in the same input. The output of the transconductor (115) is connected (116) to the load (117) which is further connected to the (analog) ground. The connection point (116) of the load (117) is connected to the output (118) of the first main gain stage (110).
The input (122) of the second main gain stage (120) is summed (124) with the input inferred noise and offset voltage (V₀₂) that represents all non-idealities of the second main gain stage (120). Such non-ideal signal obtained by summation (124) is an input to second gain stage transconductor (125) with transconductance (gₘ₂). The output of the transconductor (125) is connected (126) with (i) the output (158) of the first feed-forward gain stage (150), (ii) the load (127) connected to the (analog) ground and (iii) the output (128) of the second main gain stage (120). The MSMPFF amplifier (100) input (102) is connected to input (152) of first feed-forward gain stage (150). The input (152) of the first feed-forward gain stage (150) is summed (154) with the input inferred noise and offset voltage (V_{f2}) that represents non-idealities of the first feed-forward gain stage (150). Such non-ideal signal obtained by summation (154) is an input to the first feed-forward gain stage (150) transconductor (155) with transconductance (g_{f2}). The output of the transconductor (155) is connected (126) with the load (127) of second main gain stage (120).
The input (132) of the third main gain stage (130) is summed (134) with the input inferred noise and offset voltage (V₀₃) that represents all non-idealities of the third main gain stage (130). Such non-ideal signal obtained by summation (134) is an input to third gain stage transconductor (135) with transconductance (gₘ₃). The output of the transconductor (135) is connected (136) with (i) the output (168) of the second feed-forward gain stage (160), (ii) the load (137) connected to the (analog) ground and (iii) the output (138) of the third main gain stage (130). The MSMPFF amplifier (100) input (102) is connected to input (162) of second feed-forward gain stage (160). The input (162) of the second feed-forward gain stage (160) is summed (164) with the input inferred noise and offset voltage (V_{f3}) that represents non-idealities of the second feed-forward gain stage (160). Such non-ideal signal obtained by summation (164) is an input to the second feed-forward gain stage (160) transconductor (165) with transconductance (g_{f3}). The output of the transconductor (165) is connected (136) with the load (137) of third main gain stage (130).
There may be different number of main gain stages and related or non-related number of feed-forward stages. Each main gain stage may or may not have an accompanying feed-forward gain stage connection. FIG. 1 shows a case with n main gain stages and n−1 feed-forward gain stages, however other options are possible and come with different trade-offs.
The input (142) of the last main gain stage (140) is summed (144) with the input inferred noise and offset voltage (V₀₃) that represents all non-idealities of the last main gain stage (140). Such non-ideal signal obtained by summation (144) is an input to last gain stage transconductor (145) with transconductance (gₘₙ). The output of the transconductor (145) is connected (146) with (i) the output (188) of the last feed-forward gain stage (180), (ii) the load (147) connected to the (analog) ground and (iii) the output (148) of the last main gain stage (140). The MSMPFF amplifier (100) input (102) is connected to input (182) of last feed-forward gain stage (180). The input (182) of the last feed-forward gain stage (180) is summed (184) with the input inferred noise and offset voltage (V_{fn}) that represents non-idealities of the last feed-forward gain stage (180). Such non-ideal signal obtained by summation (184) is an input to the last feed-forward gain stage (180) transconductor (185) with transconductance (g_{fn}). The output of the transconductor (185) is connected (146) with the load (147) of last main gain stage (140).
The output (148) of the last main gain stage (140) is connected to the output (108) of the MSMPFF amplifier (100).

The MSMPFF amplifier is to output signal Vₒᵤₜ (108) that is amplified and minimally distorted transformation of signal presented on input Vᵢₙ (102). Specifically, the MSMPFF amplifier operates, in one embodiment, as follows:
The signal voltage at an input (102) to MSMPFF amplifier (100) is wired to input (112) of the first main gain stage, and to inputs (152, 162, . . . , 182) of any feed-forward gain stages (150, 160, . . . , 180). Embodiments without one or more feed-forward stages (150, 160, . . . , 180) are possible.
The signal voltage (102) on the input (112) of the first main gain stage (110) is wired to transconduction amplifier (115) that converts voltage on its input to proportional current on its output. In this process significant noise (e.g. 1/f noise, . . . ), offset voltage and other non-idealities (V₀₁) are added. This process may be modeled by explicit addition (114) of input inferred noise, offset voltage and other non-idealities (V₀₁) even though in reality these non-idealities appear internal to circuit elements used (e.g. usually predominantly transconductor (115), may also be load (117), wires, etc.).
The transconductor (115) current output connected to the load (117) causes voltage drop across the load (117) and determines the potential (voltage) V₁ at the output (118) of the first main gain stage (110) which is in turn an input (122) to second main gain stage (120).
The signal voltage on the input (122) of the second main gain stage (120) is wired to transconduction amplifier (125) that converts voltage on its input to proportional current on its output. In this process significant noise (e.g. 1/f noise, . . . ), offset voltage and other non-idealities (V₀₂) are added. This process may be modeled by explicit addition (124) of input inferred noise, offset voltage and other non-idealities (V₀₂) even though in reality these non-idealities appear internal to circuit elements used (e.g. usually predominantly transconductor (125), may also be load (127), wires, etc.).
The transconductor (125) current output and first feed-forward gain stage (150) current output (158) are both connected to the load (127) causing current flow through the load (127) and thus voltage drop across the load (127) determining the potential (voltage) V₂ at the output (128) of the second main gain stage (120) which is in turn an input (132) to third main gain stage (130). The current on the output (158) of the first feed-forward gain stage (150) is proportional to the voltage on the input of the transconductor (155) which is a sum of voltage on the input (152) and the 1/f noise, offset voltage and other non-idealities modeled and lumped as input inferred non-idealities (V_{f2}).
The signal voltage on the input (132) of the third main gain stage (130) is wired to transconduction amplifier (135) that converts voltage on its input to proportional current on its output. In this process significant noise (e.g. 1/f noise, . . . ), offset voltage and other non-idealities (V₀₃) are added. This process may be modeled by explicit addition (134) of input inferred noise, offset voltage and other non-idealities (V₀₃) even though in reality these non-idealities appear internal to circuit elements used (e.g. usually predominantly transconductor (135), may also be load (137), wires, etc.).
The transconductor (135) current output and second feed-forward gain stage (160) current output (168) are both connected to the load (137) causing current flow through the load (137) and thus voltage drop across the load (137) determining the potential (voltage) V₃ at the output (138) of the third main gain stage (130) which is in turn an input to next main gain stage. The current on the output (168) of the second feed-forward gain stage (160) is proportional to the voltage on the input of the transconductor (165) which is a sum of voltage on the input (162) and the 1/f noise, offset voltage and other non-idealities modeled and lumped as input inferred non-idealities (V_{f3}).
The signal voltage on the input (142) of the last main gain stage (140) is wired to transconduction amplifier (145) that converts voltage on its input to proportional current on its output. In this process significant noise (e.g. 1/f noise, . . . ), offset voltage and other non-idealities (V₀ₙ) are added. This process may be modeled by explicit addition (144) of input inferred noise, offset voltage and other non-idealities (V₀ₙ) (e.g. usually predominantly from transconductor (145), and may also be from load (147), wires e.g. cross-talk, etc.) even though in reality these non-idealities appear internal to circuit elements used.
The transconductor (145) current output and the last feed-forward gain stage (180) current output (188) are both connected to the load (147) causing current flow through the load (147) and thus voltage drop across the load (147) determining the potential (voltage) Vₙ at the output (148) of the last main gain stage (140) which is also an output (108) of the MSMPFF amplifier (100). The current on the output (188) of the last feed-forward gain stage (180) is proportional to the voltage on the input of the transconductor (185) which is a sum of voltage on the input (182) and the 1/f noise, offset voltage and other non-idealities modeled and lumped as input inferred non-idealities (V_{fn}).
Dominant contribution to noise, offset voltage and other non-linearities of the MSMPFF amplifier (100) are usually non-idealities (V₀₁) of the first main gain stage (110) since they are amplified by n (main) gain stages (gₘ₁·gₘ₂· . . . ·gₘₙ) where all others will usually be multiplied by fewer gain stages. In some circumstances the main non-idealities contributors may arise from different parts of the circuit. In such cases it will be clear to one skilled in the art how to determine the dominant contributors.

### Notes

There may be different numbers of main gain stages, however from the disclosure it will be clear to one skilled in the art how to construct MSMPFF amplifier with arbitrary number of main gain stages and independently arbitrary number of feed forward stages. It will be also clear to one skilled in the art how such MSMPFF amplifiers operate.
It will be clear to one skilled in the art that noise, voltage offsets and other non-idealities are unavoidable in any circuit design and do not need to be explicitly designed into circuits to be present. The modeling of such non-idealities with noise and voltage offsets (V₀₁, V₀₂, V₀₃, . . . . V₀ₙ, V_{f2}, V_{f3}, . . . . V_{fn}) (114, 124, 134, . . . , 144, 154, 164, . . . , 184) is one possible convenient way. There are other ways to perform modeling (e.g. by splitting the sources and types of non-idealities, to consider the noise, voltage offsets and other non-idealities at different pints—for example following each element, etc.) that may all be applicable to invention. It will be clear to one skilled in the art how to handle all of these variations.
It will be clear to one skilled in the art that the additions (114, 124, 134, . . . , 144, 154, 164, . . . , 184) will most often not be explicitly designed or implemented by analogue designer. The effect (noise, offset voltage and other non-idealities) will nevertheless be present in any real(istic) circuit.
It will be clear to one skilled in the art that at level of abstraction presented in the figure and relevant for such architectural design of MSMPFF amplifier, the wires are ideal and do not have any (parasitic) impedance, resistance, conductance or inductance. This is not true when taking into account circuit layout and physically implemented circuits; however, these imperfections are unavoidable and one skilled in the art will know how to deal with them. Often it is merely a matter of careful layout in order to minimize such non-idealities and accepting some minimal characteristics degradation. In the simplified model with ideal wires the following are some examples of points that are at the same potential: (i) load (117) connection point (116) of first main gain stage (110), output (118) of the first main gain stage (110) and input (122) of the second main gain stage (120), (ii) load (127) connection point (126) of the second main gain stage (120), output (128) of the first main gain stage (120), output (158) of the first feed-forward gain stage (150) and input (132) of the second main gain stage (130). Same principle applies to the rest of disclosure and all Figures.
It will also be clear to one skilled in the art that loads (117, 127, 137, . . . , 147) may be passive and generally (though not necessarily) complex, built as combination of resistive, capacitive or inductive impedances. Same applies to loads the rest of disclosure and in all Figures.
Possible are MSMPFF amplifier variants that (i) are designed as per previously described approach where transconductances gₘᵢ, g_{fi}, and impedances Zₒᵢ are selected in a way that the MSMPFF exhibits single pole transfer function, and (ii) are designed in a different way where some or all transconductances gₘᵢ,g_{fi}, and impedances Zₒᵢ are selected such that resultant amplifier exhibits a more complex (than single pole) transfer function (may also be due to imperfections of elements when implemented in silicon).
The disclosed circuits (including MSMPFF amplifier) may be implemented using single ended and/or differential signal paths (or combination thereof). The tradeoffs may depend on particular circumstances and will be apparent to one skilled in the art. Many variations, optimizations and alternative implementations applicable to conventional decimation and other digital signal processing are possible. These will be apparent to one skilled in the art and may all be applicable to invention. It will be clear to one skilled in the art that all the circuits may be implemented as single ended or as differential.

### Chopping in MSMPFF Opamp

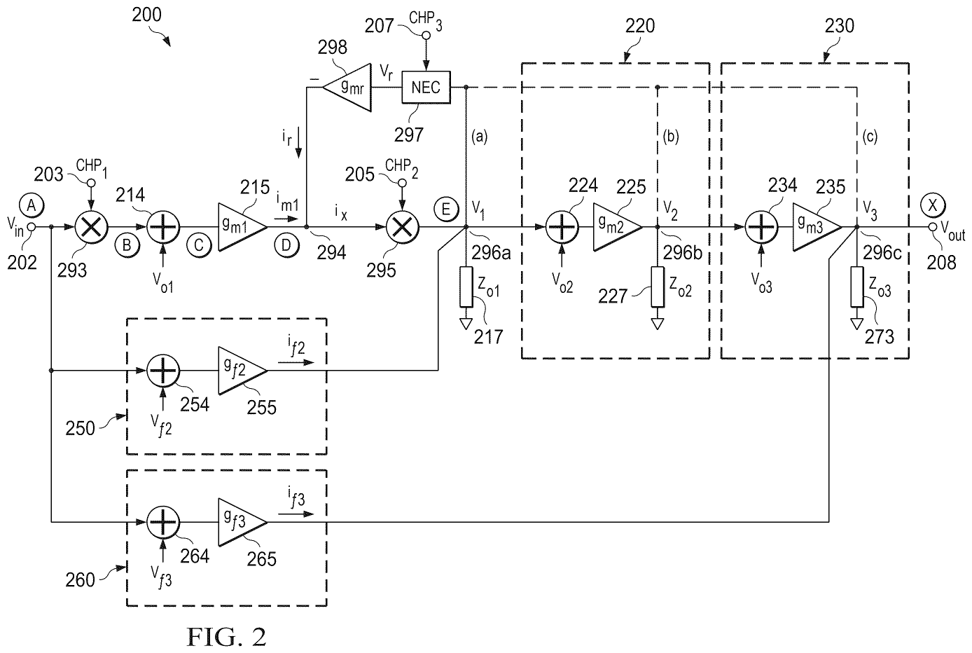

Chopping the MSMPFF amplifier may (in power efficient way) reduce the influence of the offset voltage, 1/f noise and other usually low frequency (LF) non-idealities (Vₒ₁=V_{offset1}+V_{1f}+V_{other-non-ion-idealities}) on the amplified output signal. Such non-idealities negatively impact the achievable SNR (Signal to Noise Ratio) of MSMPFF amplifier. Chopping can improve the SNR and may be implemented in several different ways as disclosed, for example, in FIGS. 2-5 in this disclosure in the example case of the 3rd order MSMPFF. Different architectures may be used according to the application and allowed remains of the non-idealities at the output since each circuit generates different remains at the output and requires different power consumption, as one skilled in the art would understand. Here for purposes of ease of description, only the possibilities for 3rd order MSMPFF opamp are described, however it will be apparent to one skilled in the art how other architectures may be used also in case of any other possible orders like 2nd, 4th, 5th order, etc. It will also be apparent to one skilled in the art how other approaches with different number of main gain stages and independently different number of feed-forward stages may be designed and what may be their trade-offs.

The basic operation of the circuit is presented in FIG. 2. Possible connections of Non-idealities Extraction Circuit (NEC) are shown as connections (a), (b) or (c). Explanation for the case of Vₒ₁ connection (a) and case where f_{CHP1}=f_{CHP2}=f_{CHP3}=f_{CHP} is as follows. Input signal is chopped by the first chopper (293), which means that input spectrum is moved to the band around f_{CHP}. For the beginning, we assume that the current iₓ=iᵣ+iₘ₁ enters the second chopper (295), where iₘ₁=(CHP·Vᵢₙ+Vₒ₁) gₘ₁ and iᵣ=gₘᵣ·k·Vᵣ where Vᵣ=Vᵢ(f_{CHP}) and k may be the (e.g. LF) gain of the feedback loop. The low frequency (LF) part of the spectrum of iₓ is transferred to the bands around f_{CHP}, while high frequency part is transferred to low frequencies. The bandwidth of the intrinsic first transconductor may be approx. 3 to 4 times the band of interest and approx. 3 to 4 times f_{CHP}, and may be selected in such a way that the signals around f_{CHP} are amplified, while lower frequency part of the transferred band of the input signal fall, in example, outside the 1/f noise corner frequency. In example, the band of interest may be for the first opamp used in LP ΣΔ ADC equal to

$${f}_{CHP} ≅ 3 \cdot {f}_{B} = 3 \cdot \frac{{f}_{ovs}}{( 2 \cdot R )} ,$$

where R is the oversampling ratio, fₒᵥₛ is sampling frequency of the modulator, f_{B} is the band of interest and f_{CHP} is a chopping frequency. The sum of chopped input voltage and Vₒ₁ is driving the gₘ₁ that generates iₘ₁. Intrinsic speed of gₘ₁ must be fast enough to accommodate that the current becomes: iₘ₁=(CHP·Vᵢₙ+Vₒ₁). gₘ₁. The resulting voltage is given in (4) and is composed of low-frequency part V₁(LF) and high frequency part V₁(HF). The non-idealities reduction loop (NRL loop) operates as negative feedback reducing the remains of the Vₒ₁ at high frequency, by large product gₘᵣ·k·Zₒ₁, where k may be the scale factor of the low frequency gain of the NRL loop.

$${V}_{1} = {V}_{1} ( LF ) + {V}_{1} ( HF ) . \qquad ( 4 )$$

$${V}_{1} ( LF ) = {V}_{in} \cdot {g}_{m 1} \cdot {Z}_{o 1}$$

$${V}_{1} ( HF ) = ( {V}_{o 1} \cdot {g}_{m 1} \cdot {Z}_{o 1} ) / ( 1 + {g}_{mr} \cdot k \cdot {Z}_{o 1} )$$

De-chopping operation brings amplified input signal down to the baseband while amplified remains of the Vₒ₁ (the difference) is translated to the band around f_{CHP} and partially filtered by Zₒ₁ frequency dependent transfer function. The compensating current iᵣ is derived from the remains of the Vₒ₁ at high frequency obtained from V₁ in the case of connection option (a) on FIG. 2, V₂ in case of connection option (b) on FIG. 2 or V₃ in case of connection option (c) on FIG. 2. The selection is dependent on the amount of the remains of the Vₒ₁ that is tolerated in the result. The offset voltage, 1/f noise and other non-idealities voltages gₘ₂ (Vₒ₂) and g_{f2} (V_{f2}) are added to the signal path. Fortunately, their contributions are significantly smaller compared to the contribution of Vₒ₁ because of the gain of the first stage. Even smaller contributions are coming from gₘ₃ (Vₒ₃) and g_{f3} (V_{f3}). The dominant contribution is thus coming from gₘ₁ because of the largest gain. Using connection (b) or (c) may reduce the amount of VNI because of higher gain and additional filtering by the action of gₘᵢ·Zₒᵢ, however, the stability of the loop must be treated accordingly. The selection is thus dependent on the application requirements related to SNR, power consumption, and stability considerations that will be clear to one skilled in the art.

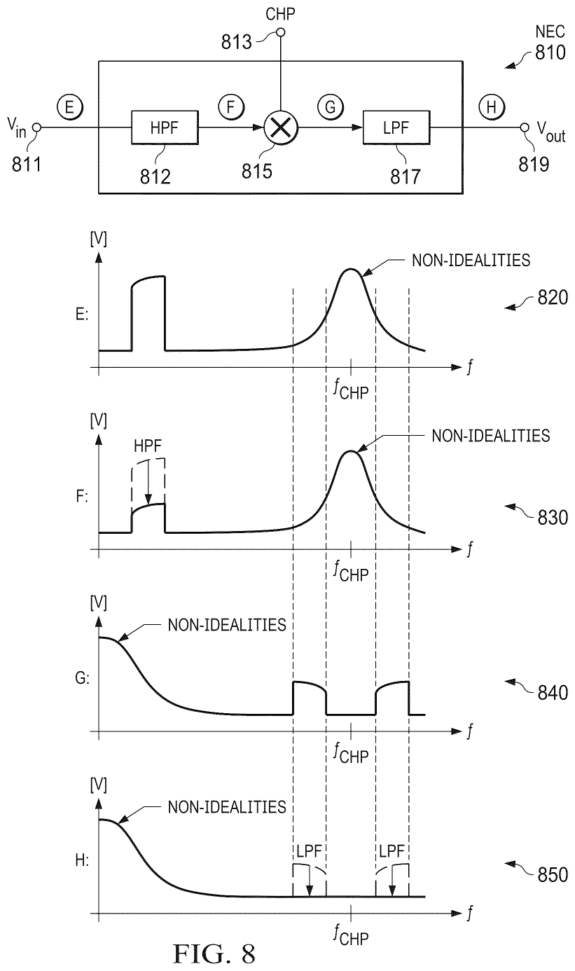

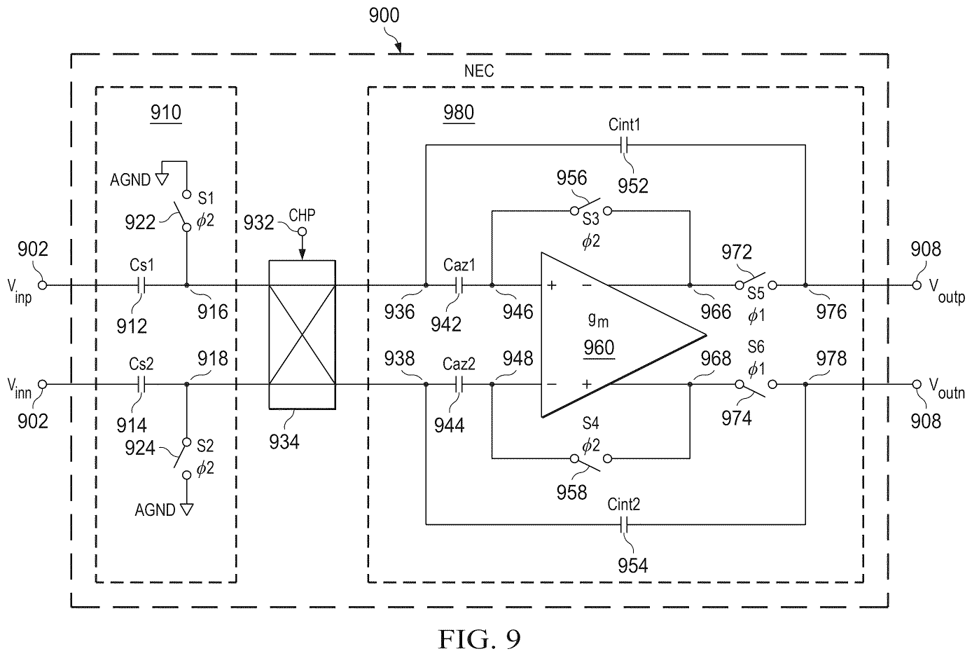

NRL (Non-idealities Reduction Loop) may be composed of NEC (Non-idealities Extraction Circuit (see e.g. FIG. 8 and FIG. 9) and transconductor gmr. In case f_{CHP}=CHP=CHP₁=CHP₂=CHP3₃ the NEC circuit may extract the remains of VNI(f_{CHP}) at the corresponding node and generates voltage Vᵣ at DC and low frequency that is proportional to the amplitude of these remains: Vᵣ=k·Vᵢ (Vₒ₁(f_{CHP})). Transconductor gmr generates current iᵣ=gₘᵣ·k·Vᵣ, which is subtracted from the current iₘ₁ coming from the gₘ₁ element. Therefore, the current iₓ=iₘ₁−iᵣ enters the second chopper with f_{CHP} chopping frequency. The iₓ at low frequencies is small if iᵣ and iₘ₁ are similar; the task of the NRL loop may be to make these two currents as equal as possible. Therefore, the NRL loop detects the remains of VNI at f_{CHP} and generates iₘ at LF. It may operate as a negative feedback amplifier, so the LF part of iₓ is highly reduced by the action of the loop, and so may also be reduced the remains of the VNI(f_{CHP}). The higher the gain in the loop, the smaller the remains are, however, the designer needs to take care of the stability of the NRL loop.

Even after chopping and NRL operation, there may still be small remains of the VNI(f_{CHP}). If f_{CHP} (or possibly distinct CHP₁, CHP₂, CHP₃) are selected carefully, then the remaining “ripple” falls into the band where e.g. shaped quantization of the ZA modulator may be present and it is removed by a digital decimation filter.

In case of using low-voltage, HF amplifiers as a building block in the HF LP continuous-time EA modulator (HF LPCT ΣΔ), which needs high gain and wide bandwidth, then the VNI(f_{CHP}) may need to be highly attenuated to achieve high SNR. Since the high frequency low power N-path ΣΔ modulator works at the baseband it may be extremely important to eliminate VNI from this band and to move the remains of VNI(f_{CHP}) to the band of shaped quantization noise.

FIG. 2 shows one embodiment of the use of chopping to remove the largest contribution of the VNI. FIG. 2 shows how 1/f noise, offset voltage and other non-idealities may be removed in MSMPFF amplifier or similar structures. For simplicity a 3rd order MSMPFF with two feed-forward stages is shown. It will be clear to one skilled in the art how to apply the invention to MSMPFF amplifier with different order and independently different number of feed-forward stages as well as to other similar circuits.

The MSMPFF amplifier with chopping (200) comprises:
An MSMPFF structure of 3rd order (see FIG. 1 for more detailed and generalized description of MSMPFF amplifier of n-th order and n−1 feed forward stages) with signal input at point A (202) of MSMPFF amplifier with chopping (200), first chopping signal input CHP₁ (203), second chopping signal input CHP₂ (205), third chopping signal input CHP₃ (207) and MSMPFF amplifier with chopping (200) output (208). In addition, there are several “virtual” non-idealities (e.g. 1/f noise, voltage offset, etc.) inputs (Vₒ₁, Vₒ₂, Vₒ₃, V_{f2}, V_{f3}) that are added (214, 224, 234, 254, 264) to the signal path. The non-idealities inputs are “virtual” because they may not be explicitly designed and implemented by analogue designer yet the non-idealities are implicitly added to the signal path by the elements (usually mainly by transconductors) themselves.
The chopping signal sources CHP₁ (203), CHP₂ (205) or CHP₃ (207) may each output a signal with at least one frequency component. The chopping signal may be a clock with certain frequency, a sinewave or some other signal usually with one defining frequency. Often it may be beneficial that the chopping signal is approximately square (clock). Some or all of the chopping signal sources CHP₁ (203), CHP₂ (205), CHP₃ (207) may be related in some way (e.g. same signal source, square clock on one and same frequency sinewave on the other, they may be synchronized, etc.). It may be beneficial that some or all are the same or have the same origin (e.g. originate from the same source, are synchronized, etc.). Simplest and most power effective option may be for all chopping signals CHP₁ (203), CHP₂ (205) and CHP₃ (207) to be a clock with appropriately (as described previously) selected frequency.
Chopper (293, see FIG. 9 one possible implementation) with first input connected to input A (202) of the MSMPFF amplifier with chopping (200) and second input connected to chopping signal source CHP₁ (203). The chopper (293) output is connected via wire B to adder (214) that may model addition of inherent first stage transconductor (215) 1/f noise, voltage offset, etc. non-idealities (Vₒ₁).
The output of the adder (214) is connected via wire C to the input of transconductor (215) with transconductance gₘ₁. The output of the transconductor (215) and the output of the transconductor (298) with transconductance gₘᵣ is connected to the current combining node D (294).
The current combining node D (294) output is connected to the first input of a (de)chopper (295). The second input of the (de)chopper (295) is connected to chopping signal source CHP₂ (205). Other configurations are also possible, as one skilled in the art would understand. The chopping signal source CHP₂ (205) may output a signal with at least one frequency component.
The output of the (de)chopper (295) is connected to a node E (296a) at potential V₁. The node (296a) at potential V₁ may be connected to (i) the output of the (de)chopper (295), and (ii) the output of the transconductor (255) with transconductance g_{f2} of the first feed-forward stage (250), and (iii) the load Zₒ₁ (217) which is on the other side connected to the (analog) ground, and (iv) the input of the adder (224) of the second gain stage (220), and (v) in case of OPTION 2(a) to the first input of the NEC (Non-idealities Extraction Circuit) (297).
The NEC (297) may have an additional (second) input (207) which is the chopping signal source CHP₃ input (207). The output of NEC (297) is connected to the input of the transconductor (298) with transconductance gₘᵣ. While all transconductors including gₘᵣ produce non-idealities, these are not modeled here as they are usually suppressed in comparison to Vₒ₁ and since they are equivalently present regardless of the NEC connection (a), (b) or (c) and may be thus, if needed, modeled as being as part of Vₒ₁. The transconductor (298) output is connected to the node (294) closing the negative feedback of the NRL loop which reduces the non-idealities. The negative feedback may be achieved by b.g. explicit inversion in the NRL, by appropriate connections in case of differential circuits or otherwise.
The adder (254) of the first feed-forward stage (250) with first input of the adder (254) connected to the input (202) of the MSMPFF amplifier with chopping (200), the adder (254) second input that may model addition of inherent second stage transconductor (255) 1/f noise, voltage offset, etc. non-idealities (V_{f2}) and adder (254) output that is connected to the input of the transconductor (255) with transconductance g_{f2}.
The transconductor (255) with transconductance g_{f2} and its output connected the node (296a) thus closing the feed-forward connection.
The adder (224) of the second main gain stage (220) with first input of the adder (224) connected to the node (296a), the adder (224) second input that may model addition of inherent second stage transconductor (225) 1/f noise, voltage offset, etc. non-idealities (Vₒ₂) and adder (224) output that is connected to the input of the transconductor (225) with transconductance gₘ₂.
The node (296b) at potential V₂ that may connect (i) the output of the transconductor (225) with the load Zₒ₂ (227) connected toward (analog) ground and (ii) the input of the adder (234) of the third main gain stage (230). In case of OPTION 2(b) the node (296b) may be also connected to the input of the NEC (297) instead of OPTION 2(a) connection from node (296a) to the input of NEC (297) or instead of OPTION 2(c) connection from node (296c) to the input NEC (297).
The adder (234) of the third main gain stage (230) with first input of the adder (234) connected to the node (296b), the adder (234) second input that may model addition of inherent third stage transconductor (235) 1/f noise, voltage offset, etc. non-idealities (Vₒ₃) and adder (234) output that is connected to the input of the transconductor (235) with transconductance gₘ₃.
The node (296c) at potential V₃ that may connect (i) the output of the transconductor (235) with the load Zₒ₃ (237) connected toward (analog) ground, and (ii) the output of the transconductor (265) with transconductance g_{f3} of the second feed-forward stage (260), and (iii) the output (208) of the MSMPFF amplifier with chopping (200). In case of OPTION 2(c) the node (296c) may also be connected to the input of the NEC (297) instead of OPTION 2(a) connection from node (296a) to the input of NEC (297) or instead of OPTION 2(b) connection from node (296b) to the input NEC (297).
The adder (264) of the second feed-forward stage (260) with first input of the adder (264) connected to the input (202) of the MSMPFF amplifier with chopping (200), the adder (264) second input that may model addition of inherent third stage transconductor (265) 1/f noise, voltage offset, etc. non-idealities (V_{f3}) and adder (264) output that is connected to the input of the transconductor (265) with transconductance g_{f3}.
The transconductor (265) with transconductance g_{f3} and its output connected the node (296c) thus closing the feed-forward connection.
The output Vₒᵤₜ (208) of the MSMPFF amplifier with chopping (200) connected with node (296c).

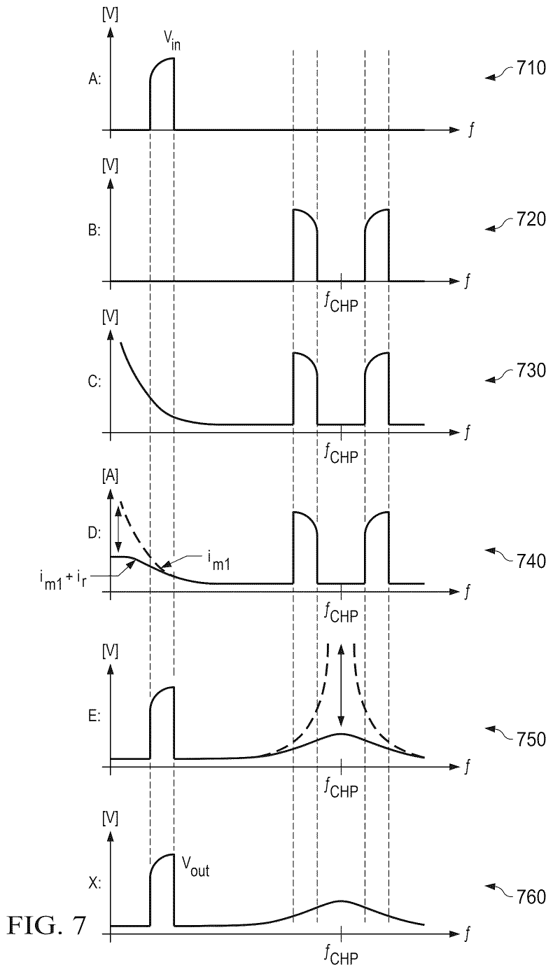

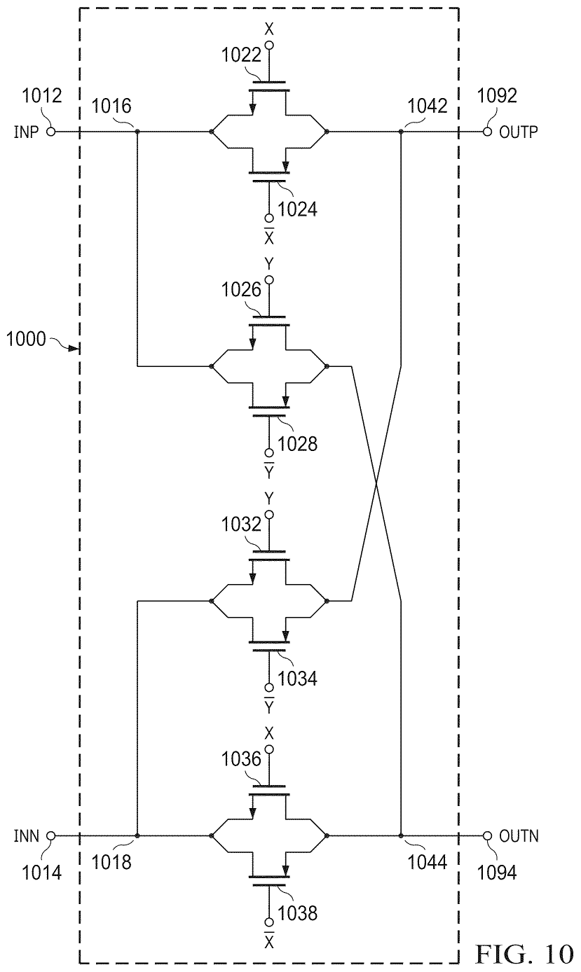

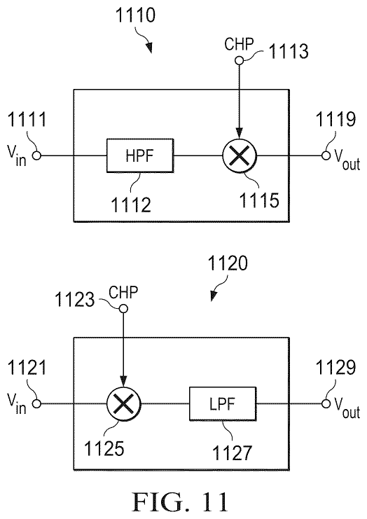

One embodiment of the operation of the MSMPFF amplifier with chopping (200) as shown in FIG. 2 is as follows:
The input signal Vᵢₙ is applied to the input (202) of the MSMPFF amplifier with chopping (200). The graph (710) of FIG. 7 shows an example of possible Vᵢₙ spectrum.
Chopper (293) operation may include transformation of the signal on its input into a form that enables later removal or avoidance of non-idealities added by the downstream elements (in example, transconductor (215). For example, the chopper (293) may implement frequency translation as shown in FIG. 7 from possible input signal Vᵢₙ (202) at node A (FIG. 2) shown in graph (710, FIG. 7) to possible translated signal on wire B (FIG. 2) shown in graph (720, FIG. 7). The chopper may be implemented for example as frequency mixer, as a simplified mixer with switches (producing also higher harmonics, which will be evident to one skilled in the art that are easily filtered), etc. One possible realization is disclosed in FIG. 10. The signal transformation performed by chopper (293) may be selected based on various system and technology parameters. As an example, the 1/f noise is by far dominant noise contribution at lower (up-to approx. order of some MHz) when implementing circuits (e.g. transconductors) in CMOS technology. The strategy may thus be to move the useful signal to higher frequencies, where 1/f noise is negligible. In case of simple frequency translation, the chopper (293) input CHP₁ (203) may be a simple clock or sinewave with frequency f_{CHP1}. One skilled in the art will know how to perform proper frequency planning such that the useful signal (e.g. Vᵢₙ) is not destroyed.
The 1/f noise, voltage offset and other non-idealities are produced by circuits implementing the MSMPFF amplifier with chopping (200). The adders (214, 224, 234, 254, 264) are usually not implemented explicitly in circuits but are used as a way to model such inherent and unavoidable non-idealities of components (e.g. transconductors) used to implement MSMPFF amplifier with chopping. The signals on inputs (Vₒ₁, Vₒ₂, Vₒ₃, V_{f2}, V_{f3}) comprise such unavoidable (and modeled) non-idealities (e.g. 1/f noise, voltage offset, etc.) and are added (214, 224, 234, 254, 264) to the signal path. An example of addition of such non-idealities modeled on wire C (FIG. 2) is shown in graph (730, FIG. 7). Depicted is additional noise at low frequencies.
The transconductor (215) with transconductance gₘ₁ converts voltage present on its input (on wire C) and shown in graph (730, FIG. 7) to proportional current iₘ₁ on its output and shown with dashed line in graph (740, FIG. 7). At node D (294) the current iₘ₁ from transconductor (215) and iᵣ from noise reduction feedback loop transconductor (298) converge (are summed) as shown with full line on graph (740, FIG. 7). The output of transconductor (298) is such that iᵣ corresponds to inversion of the noise to be removed as much as possible. This way the summed signal current of iₘ₁+iᵣ at node D contains less noise (and/or other non-idealities) than signal on wire C.
The (de)chopper (295) operation may include transformation of the signal on its input from a form that enabled removal or avoidance of non-idealities added by the circuit elements (in example, transconductor (215)) to an original form or to a form that is similar enough for purpose of the MSMPFF amplifier with chopping (200). For example, the (de)chopper (295) may implement frequency translation as shown in FIG. 7 from possible signal at its input at node D (FIG. 2) shown with solid line in graph (740, FIG. 7) to possible (e.g. back) translated signal at node E (FIG. 2) shown in graph (750, FIG. 7). The (de)chopper may be implemented for example as frequency mixer, as a simplified mixer with switches (producing also higher harmonics, which will be evident to one skilled in the art that are easily filtered), etc. The signal transformation performed by (de)chopper (295) may be selected based on various system and technology parameters including operation of chopper (293). In case of simple frequency translation, the (de)chopper (295) input CHP₂ (205) may be a simple clock or sinewave with frequency f_{CHP2}. One skilled in the art will know how to perform proper frequency planning such that the useful signal (e.g. Vᵢₙ) is sufficiently preserved.
The load Zₒ₁ (217) may be passive and generally (though not necessarily) complex, built as combination of resistive, capacitive or inductive impedances. The current flow through the load (217) to the (analog) ground defines the potential V₁ at node E (296a). Defined also by parasitics in real circuits the circuit exhibits a low pass filtering transfer function that may be taken advantage of in removing noise, images and other non-idealities at higher frequencies.
The NEC (297) operation may include extraction of the unwanted (non-idealities) signal components present in NEC (297) input which may be connected to different points in the circuit as shown in OPTION 2(a), OPTION 2(b) and OPTION 2(c) connections. The extraction of non-idealities may be achieved by NEC (297) implementation as e.g., shown in FIG. 8 (810), FIG. 9 (900), FIG. 11 (1110), FIG. 1120, etc. In case of NEC (297) implementation as shown in FIG. 8 (810) the signal on the input of the NEC (811, FIG. 8) may be connected to the input of high pass filter HPF (812). The signal at point E (FIG. 8) at the input of the high pass filter HPF (812, FIG. 8) may be as shown in graph (820), FIG. 8. The output of the HPF (812, FIG. 8) at point F (FIG. 8) may be as shown in graph (830, FIG. 8). The output of HPF FIG. 8 (812) may be connected to the first input of the chopper (815, FIG. 8). Chopper (815, FIG. 8) may perform simple frequency translation. The chopper (815, FIG. 8) second input CHP (813, FIG. 8) may be a simple clock or sinewave with frequency f_{CHP}. One skilled in the art will know how to perform proper frequency planning such that the non-idealities to be removed are appropriately preserved. One possible implementation of chopper (815, FIG. 8) is the same as that of chopper (293). In such case it may be simplest if also the chopper (815, FIG. 8) input (813, FIG. 8) is the same as input (203) of the chopper (293). Other options will be clear to one skilled in the art and are part of the invention. For example, the chopper (815, FIG. 8) embedded in implementation of NEC (297) may implement frequency translation as shown in FIG. 8 from possible signal at its input at node F (FIG. 8) shown in graph (830, FIG. 8) to possible translated signal on connection G (FIG. 8) shown in graph (840, FIG. 8). The next step in extraction of unwanted non-idealities may be low pass filtering performed by a low pass filter LPF (817, FIG. 8). In example, the input to the low pass filter LPF (817, FIG. 8) may be signal on connection G (FIG. 8) shown in graph (840, FIG. 8) and the filtered signal with isolated non-idealities on the output H (FIG. 8) may be as shown in graph (850, FIG. 8). It may be important to realize that NEC (297) operates in a feedback loop. For this reason the suppression of unwanted non-idealities shown in FIG. 8 as the difference from signals with dashed lines to the signals with solid lines is achieved due to the feedback loop. Another possible realization of the NEC (297) that may have better characteristics in certain cases is shown in FIG. 9.
The transconductor (298) with transconductance gₘᵣ converts voltage present on its input (on wire H, FIG. 8) and shown in graph (850, FIG. 8) to negated proportional current iᵣ on its output. The negation (inversion) may be implemented with transconductor (298) or previously as part of NEC (297) operation or otherwise. What is important is that iᵣ when combined with iₘ₁ at node (294) closes the negative feedback loop and that the desired reduction/removal of non-idealities is achieved. It will be clear to one in the art how to achieve appropriate negation and how to design the negative feedback loop with appropriate stability.
The second main gain stage (220), the third main gain stage (230), first feed-forward stage (250) and the second feed-forward stage (260) operate as previously disclosed related to MSMPFF amplifier operation.
The output Vₒᵤₜ (208) of the MSMPFF amplifier with chopping (200) with reduced non-idealities is shown at node X in a graph (760, FIG. 7).

### Notes

Described above as OPTION 2(a) with connection from node (296a) to input of the NEC (297). Possible are also OPTION 2(b) drawn with dashed lines with connection from node (296b) to input of NEC (297) instead of connection from node (296a) to input of NEC (297) in OPTION 2(a) and OPTION 2(c) drawn with dashed lines with connection from node (296c) to input of NEC (297) instead of connection from node (296a) to input of NEC (297) in OPTION 2(a). Each of the options may come with their specific trade-offs analysis and implementation of which will be clear to one skilled in the art. Other options are also possible, as one skilled in the art would understand.
One purpose of feed-forward stages (250) and (260) may be to perform compensation for stability when MSMPFF amplifier with chopping (200) is operated in circuits with feedback. As previously described (e.g. see FIG. 1) the goal of such feed-forward structures may be to implement dominant or reduced pole transfer function of the MSMPFF amplifier with chopping.
Possible are other connections of the feed-forward structures (250) and (260) as well as different number of them. These and their analysis will be clear from the disclosure to one skilled in the art. For example, the output of feed-forward stage (250) may be connected to node (296b) or node (296c) instead of node (296a). Also, in example the feed-forward stage (260) may be connected to node (296a) or node (296b) instead of node (296c). As an additional example the feed-forward stage (250) and/or (260) may not be implemented, etc. It will be clear to one skilled in the art from the disclosure how to implement and analyze such adaptation.
It will be clear to one skilled in the art that adders (214), (224), (234), (254) and (264) need not be explicitly added to the implemented circuits.
Chopping as disclosed may be applied to (i) MSMPFF amplifier that is designed as per described procedure where transconductances gₘᵢ,g_{fi}, and impedances Zₒᵢ are selected in a way that the MSMPFF exhibits single pole transfer function, or (ii) to MSMPFF amplifier where transconductances gₘᵢ g_{fi}, and impedances Zₒᵢ are not selected in such way and resultant amplifier exhibits a more complex transfer function (may also be due to imperfections of elements when implemented in silicon), as well as (iii) to other MSMPFF-like structures.

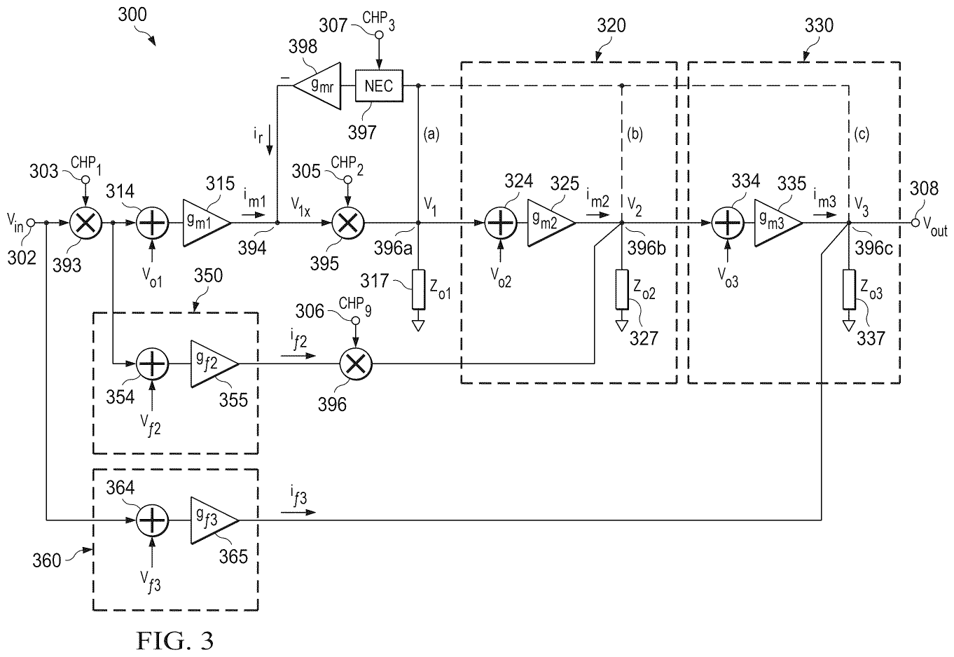

FIGS. 3-5 show different possibilities for the connection of chopping and de-chopping and connection of NEC circuit. Each has its own advantages and disadvantages. FIG. 3 shows alternative embodiments of MSMPFF chipping amplifier with different connections of chopping, (de) chopping and NEC circuits. Embodiments shown in FIG. 3 may additionally suppress non-idealities caused by transconductor in feed-forward connection.

It will be clear to one skilled in the art how to apply the invention to MSMPFF amplifiers with different orders and independently different number of feed-forward stages as well as to other similar circuits.

The MSMPFF amplifier with chopping (300) of FIG. 3 comprises:
An MSMPFF structure of 3rd order (see FIG. 1 for more detailed and generalized description of MSMPFF amplifier of n-th order and n-1 feed forward stages) with signal input (302) of MSMPFF amplifier with chopping (300), first chopping signal input CHP₁ (303), second chopping signal input CHP₂ (305), third chopping signal input CHP₃ (307), fourth chopping signal input CHP₉ (306) and MSMPFF amplifier with chopping (300) output (308). In addition, there are several “virtual” non-idealities VNI's (e.g. 1/f noise, voltage offset, etc.) inputs (Vₒ₁, Vₒ₂, Vₒ₃, V_{f2}, V_{f3}) that are added (314, 324, 334, 354, 364) to the signal path. The non-idealities inputs are “virtual” because they may not be explicitly designed and implemented by analogue designer yet the non-idealities are implicitly added to the signal path by the elements (usually mainly by transconductors) themselves.
The chopping signal sources CHP₁ (303), CHP₂ (305), CHP₃ (307) or CHP₉ (306) may each output a signal with at least one frequency component. The chopping signal may be a clock with certain frequency, a sinewave or some other signal usually with one defining frequency. Often it may be beneficial that the chopping signal is approximately square (clock). Some or all of the chopping signal sources CHP₁ (303), CHP₂ (305), CHP₃ (307), CHP₉ (306) may be related in some way (e.g. same signal source, square clock on one and same frequency sinewave on the other, they may be synchronized, etc.). It may be beneficial that some or all are the same or have the same origin (e.g. originate from the same source, are synchronized, etc.). Simplest and most power effective option may be for all chopping signals CHP₁ (303), CHP₂ (305), (307) and CHP₉ (306) to be a clock with appropriately (as described previously) selected frequency.
Chopper (393, e.g., see FIG. 8 and FIG. 9 for some possible implementations) with first input connected to input (302) of the MSMPFF amplifier with chopping (300) and second input connected to chopping signal source CHP₁ (303). The chopper (393) output is connected to adder (314) that may model addition of inherent first stage transconductor (315) 1/f noise, voltage offset and other non-idealities (Vₒ₁).
The output of the adder (314) is connected to the input of transconductor (315) with transconductance gₘ₁. The output of the transconductor (315) and the output of the transconductor (398) with transconductance gₘᵣ is connected to the current combining node (394).
The current combining node (394) output is connected to the first input of a (de)chopper (395). The second input of the (de)chopper (395) is connected to chopping signal source CHP₂ (305). The chopping signal source CHP₂ (305) may output a signal with at least one frequency component.
The output of the (de)chopper (395) is connected to a node (396a) at potential V₁. The node (396a) at potential V₁ may be connected to (i) the output of the (de)chopper (395), and (ii) the load Zₒ₁ (317) which is on the other side connected to the (analog) ground, and (iii) the input of the adder (324) of the second gain stage (320), and (iv) in case of OPTION 3(a) to the first input of the NEC (Non-idealities Extraction Circuit) (397). In case of OPTION 3(b) or OPTION 3(c) the connection (iv) to the first input of NEC (397) may not exist from node (396a).
The NEC (397) may have an additional (second) input (307) which is the chopping signal source CHP₃ input (307). The output of NEC (397) is connected to the input of the transconductor (398) with transconductance gₘᵣ. While all transconductors including gₘᵣ produce non-idealities, these are not modeled here as they are usually suppressed in comparison to Vₒ₁ and since they are equivalently present regardless of the NEC connection (a), (b) or (c) and may be thus, if needed, modeled as being as part of Vₒ₁. The transconductor (398) output is connected to the node (394) closing the negative feedback of the NRL loop which reduces the non-idealities. The negative feedback may be achieved by b.g. explicit inversion in the NRL, by appropriate connections in case of differential circuits or otherwise.
The adder (324) of the second main gain stage (320) with first input of the adder (324) connected to the node (396a), the adder (324) second input that may model addition of inherent second stage transconductor (325) 1/f noise, voltage offset, etc. non-idealities (Vₒ₂) and adder (324) output that is connected to the input of the transconductor (325) with transconductance gₘ₂.
The node (396b) at potential V₂ that may connect (i) the output of the transconductor (325), (ii) the output of the chopper (396) following the first feed-forward stage (350), and (iii) the load Zₒ₂ (327) connected toward (analog) ground and (iv) the input of the adder (334) of the third main gain stage (330). In case of OPTION 3(b) the node (396b) may be also connected to the input of the NEC (397) instead of OPTION 3(a) connection from node (396a) to the input of NEC (397) or instead of OPTION 3(c) connection from node (396c) to the input NEC (397).
The adder (354) of the first feed-forward stage (350) with first input of the adder (354) connected to the output of the chopper (393), the adder (354) second input that may model addition of inherent second stage transconductor (355) 1/f noise, voltage offset, etc. non-idealities (V_{f2}) and adder (354) output that is connected to the input of the transconductor (355) with transconductance g_{f2}.
The transconductor (355) with transconductance g_{f2} and its output connected the (de)chopper (396).
The (de)chopper (396) with its first input connected to the output of transconductor (355). The second input of the (de)chopper (396) is connected to chopping signal source CHP₉ (306). The chopping signal source CHP₉ (306) may output a signal with at least one frequency component. The (de)chopper (396) output may be connected to the node (396b) thus closing the feed-forward connection.
The adder (334) of the third main gain stage (330) with first input of the adder (334) connected to the node (396b), the adder (334) second input that may model addition of inherent third stage transconductor (335) 1/f noise, voltage offset, etc. non-idealities (Vₒ₃) and adder (334) output that is connected to the input of the transconductor (335) with transconductance gₘ₃.
The node (396c) at potential V₃ that may connect (i) the output of the transconductor (335) with the load Zₒ₃ (337) connected toward (analog) ground, and (ii) the output of the transconductor (365) with transconductance g_{f3} of the second feed-forward stage (360), and (iii) the output (308) of the MSMPFF amplifier with chopping (300). In case of OPTION 3(c) the node (396c) may also be connected to the input of the NEC (397) instead of OPTION 3(a) connection from node (396a) to the input of NEC (397) or instead of OPTION 3(b) connection from node (396b) to the input NEC (397).
The adder (364) of the second feed-forward stage (360) with first input of the adder (364) connected to the input (302) of the MSMPFF amplifier with chopping (300), the adder (364) second input that may model addition of inherent third stage transconductor (365) 1/f noise, voltage offset, etc. non-idealities (V_{f3}) and adder (364) output that is connected to the input of the transconductor (365) with transconductance g_{f3}.
The transconductor (365) with transconductance g_{f3} and its output connected the node (396c) thus closing the feed-forward connection.
The output Vₒᵤₜ (308) of the MSMPFF amplifier with chopping (300) connected with node (396c).

One embodiment of the operation of the MSMPFF amplifier with chopping (300) of FIG. 3 is as follows:
The input signal Vᵢₙ is applied to the input (302) of the MSMPFF amplifier with chopping (300).
Chopper (393) operation may include transformation of the signal on its input into a form that enables later removal or avoidance of non-idealities added by the downstream elements (in example, transconductor (315). For example, the chopper (393) may implement frequency translation of the possible input signal Vᵢₙ (302). The chopper may be implemented for example as frequency mixer, as a simplified mixer with switches (producing also higher harmonics, which will be evident to one skilled in the art that are easily filtered), etc. One possible realization is disclosed in FIG. 10. The signal transformation performed by chopper (393) may be selected based on various system and technology parameters. As an example, the 1/f noise is by far dominant noise contribution at lower (up-to approx. order of some MHz) when implementing circuits (e.g. transconductors) in CMOS technology. The strategy may thus be to move the useful signal to higher frequencies, where 1/f noise is negligible. In case of simple frequency translation, the chopper (393) input CHP₁ (303) may be a simple clock or sinewave with frequency f_{CHP1}. One skilled in the art will know how to perform proper frequency planning such that the useful signal (e.g. Vᵢₙ) is not destroyed.
The 1/f noise, voltage offset and other non-idealities are produced by circuits implementing the MSMPFF amplifier with chopping (300). The adders (314, 324, 334, 354, 364) are usually not implemented explicitly in circuits but are used as a way to model such inherent and unavoidable non-idealities of components (e.g. transconductors) used to implement MSMPFF amplifier with chopping. The signals on inputs (Vₒ₁, Vₒ₂, Vₒ₃, V_{f2}, V_{f3}) comprise such unavoidable (and modeled) non-idealities (e.g. 1/f noise, voltage offset, etc.) and are added (314, 324, 334, 354, 364) to the signal path.
The transconductor (315) with transconductance gₘ₁ converts voltage present on its input to proportional current iₘ₁ on its output. At node (394) the current iₘ₁ from transconductor (315) and iᵣ from noise reduction feedback loop (NRL) transconductor (398) converge (are summed). The output of transconductor (398) is such that iᵣ corresponds to inversion of the noise to be removed as much as possible. This way the summed signal current of iₘ₁+iᵣ at node (394) contains less noise (and/or other non-idealities) versus the case without the noise reduction loop NRL.
The (de)chopper (395) operation may include transformation of the signal on its input from a form that enabled removal or avoidance of non-idealities added by the circuit elements (in example, transconductor (315)) to an original form or to a form that is similar enough for purpose of the MSMPFF amplifier with chopping (300). For example, the (de)chopper (395) may implement frequency translation. The (de)chopper may be implemented for example as frequency mixer, as a simplified mixer with switches (producing also higher harmonics, which will be evident to one skilled in the art that are easily filtered), etc. One possible realization is disclosed in FIG. 10. The signal transformation performed by (de)chopper (395) may be selected based on various system and technology parameters including operation of chopper (393). In case of simple frequency translation, the (de)chopper (395) input CHP₂ (305) may be a simple clock or sinewave with frequency f_{CHP2}. One skilled in the art will know how to perform proper frequency planning such that the useful signal (e.g. Vᵢₙ) is sufficiently preserved.
The load Zₒ₁ (317) may be passive and generally (though not necessarily) complex, built as combination of resistive, capacitive or inductive impedances. The current flow through the load (317) to the (analog) ground defines the potential V₁ at node (396a). Defined also by parasitics in real circuits the circuit exhibits a low pass filtering transfer function that may be taken advantage of in removing noise, images and other non-idealities at higher frequencies.
The NEC (397) operation may include extraction of the unwanted (non-idealities) signal components present in NEC (397) input which may be connected to different points in the circuit as shown in OPTION 3(a), OPTION 3(b) and OPTION 3(c) connections. The extraction of non-idealities may be achieved by NEC (397) implementation as e.g. shown in FIG. 8 (810), FIG. 9 (900), FIG. 11 (1110), FIG. 1120, etc. In case of NEC (397) implementation as shown in FIG. 8 (810) the signal on the input of the NEC (811, FIG. 8) may be connected to the input of high pass filter HPF (812). The signal at point E (FIG. 8) at the input of the high pass filter HPF (812, FIG. 8) may be as shown in graph (820), FIG. 8. The output of the HPF (812, FIG. 8) at point F (FIG. 8) may be as shown in graph (830, FIG. 8). The output of HPF FIG. 8 (812) may be connected to the first input of the chopper (815, FIG. 8). Chopper (815, FIG. 8) may perform simple frequency translation. The chopper (815, FIG. 8) second input CHP (813, FIG. 8) may be a simple clock or sinewave with frequency f_{CHP}. One skilled in the art will know how to perform proper frequency planning such that the non-idealities to be removed are appropriately preserved. One possible implementation of chopper (815, FIG. 8) is the same as that of chopper (393). In such case it may be simplest if also the chopper (815, FIG. 8) input (813, FIG. 8) is the same as input (303) of the chopper (393). Other options will be clear to one skilled in the art and are part of the invention. For example, the chopper (815, FIG. 8) embedded in implementation of NEC (397) may implement frequency translation as shown in FIG. 8 from possible signal at its input at node F (FIG. 8) shown in graph (830, FIG. 8) to possible translated signal on connection G (FIG. 8) shown in graph (840, FIG. 8). The next step in extraction of unwanted non-idealities may be low pass filtering performed by a low pass filter LPF (817, FIG. 8). In example, the input to the low pass filter LPF (817, FIG. 8) may be signal on connection G (FIG. 8) shown in graph (840, FIG. 8) and the filtered signal with isolated non-idealities on the output H (FIG. 8) may be as shown in graph (850, FIG. 8). It may be important to realize that NEC (397) operates in a feedback loop. For this reason the suppression of unwanted non-idealities shown in FIG. 8 as the difference from signals with dashed lines to the signals with solid lines is achieved due to the feedback loop. Another possible realization of the NEC (397) that may have better characteristics in certain cases is shown in FIG. 9.
The transconductor (398) with transconductance gₘᵣ converts voltage present on its input as may be shown in graph (850, FIG. 8) to negated proportional current iᵣ on its output. The negation (inversion) may be implemented with transconductor (398) or previously as part of NEC (397) operation or otherwise. What is important is that iᵣ when combined with iₘ₁ at node (394) closes the negative feedback loop and that the desired reduction/removal of non-idealities is achieved. It will be clear to one in the art how to achieve appropriate negation and how to design the negative feedback loop with appropriate stability.
The second main gain stage (320), the third main gain stage (330) and the second feed-forward stage (360) operate as previously disclosed related to MSMPFF amplifier operation.
The first feed-forward stage may have a chopper (396) connected to the output of the transconductor (355). The (de)chopper (396) operation may include transformation of the signal on its input from a form that enabled removal or avoidance of non-idealities added by the circuit elements (in example, transconductor (355)) to an original form or to a form that is similar enough for purpose of the MSMPFF amplifier with chopping (300). For example, the (de)chopper (396) may implement frequency translation that is an inverse of chopper (393) frequency translation.
The output (308) of the MSMPFF amplifier with chopping (300) may have reduced non-idealities in comparison with corresponding MSMPFF amplifier without chopping.

### Notes

Above described is OPTION 3(a) with connection from node (396a) to input of the NEC (397). Possible are also OPTION 3(b) drawn with dashed lines with connection from node (396b) to input of NEC (397) instead of connection from node (396a) to input of NEC (397) in OPTION 3(a) and OPTION 3(c) drawn with dashed lines with connection from node (396c) to input of NEC (397) instead of connection from node (396a) to input of NEC (397) in OPTION 3(a). Each of the options may come with their specific trade-offs analysis and implementation of which will be clear to one skilled in the art. Other options are also possible, as one skilled in the art would understand.
One purpose of feed-forward stages (350) and (360) may be to perform compensation for stability when MSMPFF amplifier with chopping (300) is operated in circuits with feedback. As previously described (e.g. see FIG. 1) the goal of such feed-forward structures may be to implement dominant or reduced pole transfer function of the MSMPFF amplifier with chopping.
Possible are other connections of the feed-forward structures (350) and (360) as well as different number of them. These and their analysis will be clear from the disclosure to one skilled in the art. For example, the output of feed-forward stage (350) may be connected to node (396a) instead of node (396b). Also, in example the feed-forward stage (360) may be connected to node (396a) or node (396b) instead of node (396c). As an additional example the feed-forward stage (350) and/or (360) may not be implemented, etc. It will be clear to one skilled in the art from the disclosure how to implement and analyze such adaptation.
It will be clear to one skilled in the art that adders (314), (324), (334), (354) and (364) need not be explicitly added to the implemented circuits.

Higher order MSMPFF amplifiers (4th, 5th . . . ) with chopping possibilities may be constructed following the same principles as disclosed, as one skilled in the art would understand . . . Choppers and (de)choppers are placed according to the needs related to required SNR and power consumption. The chopping frequency depends on the application.

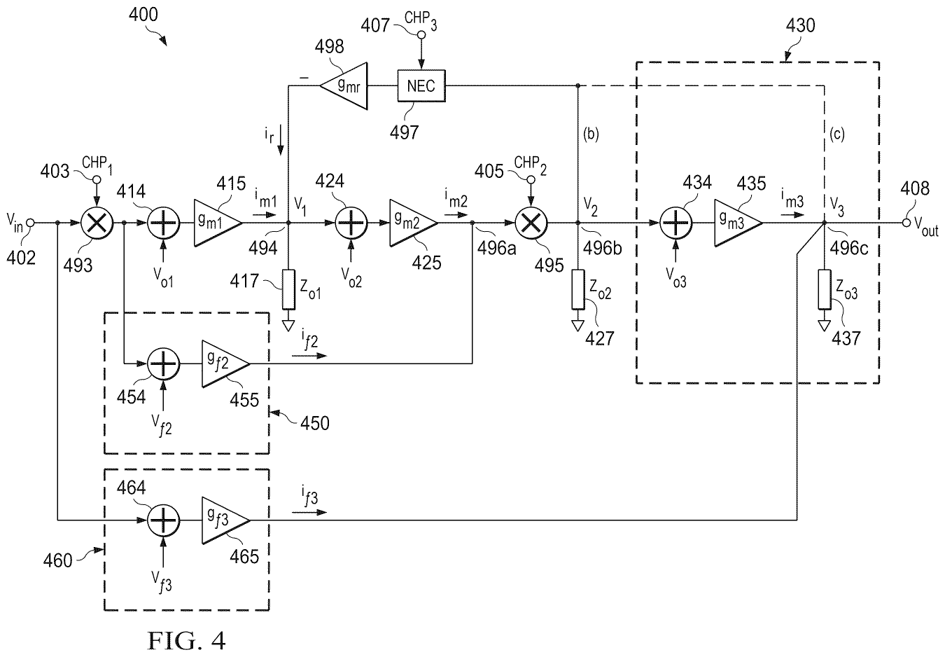

FIG. 4 shows alternative embodiments of MSMPFF chopping amplifier with different connections of chopping, (de) chopping and NEC circuits. Embodiments shown in FIG. 4 may additionally suppress non-idealities caused by second main gain stage transconductor with transconductance gₘ₂.

It will be clear to one skilled in the art how to apply the invention to MSMPFF amplifier with different order and independently different number of feed-forward stages as well as to other similar circuits.

One embodiment of an MSMPFF amplifier with chopping (400) as shown in FIG. 4 comprises:
An MSMPFF structure of 3rd order (see FIG. 1 for more detailed and generalized description of MSMPFF amplifier of n-th order and n-1 feed forward stages) with signal input (402) of MSMPFF amplifier with chopping (400), first chopping signal input CHP₁ (403), second chopping frequency input CHP₂ (405), third chopping signal input CHP₃ (407) and MSMPFF amplifier with chopping (400) output (408). In addition, there are several “virtual” non-idealities VNI's (e.g. 1/f noise, voltage offset, etc.) inputs (Vₒ₁, Vₒ₂, Vₒ₃, V_{f2}, V_{f3}) that are added (414, 424, 434, 454, 464) to the signal path. The non-idealities inputs are “virtual” because they may not be explicitly designed and implemented by analogue designer yet the non-idealities are implicitly added to the signal path by the elements (usually mainly by transconductors) themselves.
The chopping signal sources CHP₁ (403), CHP₂ (405) or CHP₃ (407) may each output a signal with at least one frequency component. The chopping signal may be a clock with certain frequency, a sinewave or some other signal usually with one defining frequency. Often it may be beneficial that the chopping signal is approximately square (clock). Some or all of the chopping signal sources CHP₁ (403), CHP₂ (405), CHP₃ (407) may be related in some way (e.g. same signal source, square clock on one and same frequency sinewave on the other, they may be synchronized, etc.). It may be beneficial that some or all are the same or have the same origin (e.g. originate from the same source, are synchronized, etc.). Simplest and most power effective option may be for all chopping signals CHP₁ (403), CHP₂ (405) and CHP₃ (407) to be a clock with appropriately (as described previously) selected frequency.
Chopper (493, see FIG. 9 for one possible implementation) with first input connected to input (402) of the MSMPFF amplifier with chopping (400) and second input connected to chopping signal source CHP₁ (403). The chopper (493) output is connected to adder (414) that may model addition of inherent first stage transconductor (415) 1/f noise, voltage offset and other non-idealities (Vₒ₁).
The output of the adder (414) is connected to the input of transconductor (415) with transconductance gₘ₁. The output of the transconductor (415) and the output of the transconductor (498) with transconductance gₘᵣ is connected to the current combining node (494).
The node (494) may be connected to (i) the output of the transconductor (415) with transconductance gₘ₁, and (ii) the output of the transconductor (498) with transconductance gₘᵣ, and (iii) the load Zₒ₁ (417) which is on the other side connected to the (analog) ground, and (iv) to the first input of the adder (424).
The adder (424) second input may model addition of inherent second main stage transconductor (425) 1/f noise, voltage offset, etc. non-idealities (Vₒ₂). The adder (424) output may be connected to the input of the second main gain transconductor (425) with transconductance gₘ₂.
The transconductor (425) output and the output of the transconductor (455) of the first feed-forward stage (450) with transconductance g_{f2} may be connected to the current combining node (496a).
The current combining node (496a) connecting (i) the output of the transconductor (425) with transconductance gₘ₂, (ii) the output of the first feed-forward stage with transconductance g_{f2} transconductor (455), and (iii) the first input of the chopper (495).
The adder (454) of the first feed-forward stage (450) with first input of the adder (454) connected to the output of the chopper (493), the adder (454) second input that may model addition of inherent second stage transconductor (455) 1/f noise, voltage offset, etc. non-idealities (V_{f2}) and adder (454) output that is connected to the input of the transconductor (455) with transconductance g_{f2}.
The current combining node (496a) output is connected to the (de)chopper (495) first input. The second input of the (de)chopper (495) is connected to chopping signal source CHP₂ (405). The chopping signal source CHP₂ (405) may output a signal with at least one frequency component.
The output of the (de)chopper (495) is connected to the node (496b) at potential V₂. The node (496b) at potential V₂ may connect (i) the output of the (de)chopper (495), and (ii) the load Zₒ₂ (427) connected toward (analog) ground, and (iii) the input of the adder (434) of the third main gain stage (430), and (iv) in case of OPTION 4(b) to the first input of the NEC (Non-idealities Extraction Circuit) (497). In case of OPTION 4(c) the connection (iv) to the first input of NEC (497) may not exist from node (496b).
The NEC (497) may have an additional (second) input (407) which is the chopping signal source CHP₃ input (407). The output of NEC (497) is connected to the input of the transconductor (498) with transconductance gₘᵣ. While all transconductors including gₘᵣ produce non-idealities, these are not modeled here as they are usually suppressed in comparison to Vₒ₁ and since they are equivalently present regardless of the NEC connection (b) or (c) and may be thus, if needed, modeled as being as part of Vₒ₁. The transconductor (498) output is connected to the node (494) closing the negative feedback of the NRL loop which reduces the non-idealities. The negative feedback may be achieved by b.g. explicit inversion in the NRL, by appropriate connections in case of differential circuits or otherwise.
The adder (434) of the third main gain stage (430) with first input of the adder (434) connected to the node (496b), the adder (434) second input that may model addition of inherent third stage transconductor (435) 1/f noise, voltage offset, etc. non-idealities (Vₒ₃) and adder (434) output that is connected to the input of the third main gain stage transconductor (435) with transconductance gₘ₃.
The node (496c) at potential V₃ that may connect (i) the output of the transconductor (435) with the load Zₒ₃ (437) connected toward (analog) ground, and (ii) the output of the transconductor (465) with transconductance g_{f3} of the second feed-forward stage (460), and (iii) the output (408) of the MSMPFF amplifier with chopping (400). In case of OPTION 4(c) the node (496c) may also be connected to the input of the NEC (497) instead of OPTION 4(b) connection from node (496b) to the input of NEC (497).
The adder (464) of the second feed-forward stage (460) with first input of the adder (464) connected to the input (402) of the MSMPFF amplifier with chopping (400), the adder (464) second input that may model addition of inherent third stage transconductor (465) 1/f noise, voltage offset, etc. non-idealities (V_{f3}) and adder (464) output that is connected to the input of the transconductor (465) with transconductance g_{f3}.
The transconductor (465) with transconductance g_{f3} and its output connected the node (496c) thus closing the feed-forward connection.
The output Vₒᵤₜ (408) of the MSMPFF amplifier with chopping (400) connected with node (496c).

One embodiment of the operation of the MSMPFF amplifier with chopping (400) of FIG. 4 is as follows:
The input signal Vᵢₙ is applied to the input (402) of the MSMPFF amplifier with chopping (400).
Chopper (493) operation may include transformation of the signal on its input into a form that enables later removal or avoidance of non-idealities added by the downstream elements (in example, transconductor (415)). For example, the chopper (493) may implement frequency translation of the possible input signal Vᵢₙ (402). The chopper may be implemented for example as frequency mixer, as a simplified mixer with switches (producing also higher harmonics, which will be evident to one skilled in the art that are easily filtered), etc. One possible realization is disclosed in FIG. 10. The signal transformation performed by chopper (493) may be selected based on various system and technology parameters. As an example, the 1/f noise is by far dominant noise contribution at lower (up-to approx. order of some MHz) when implementing circuits (e.g. transconductors) in CMOS technology. The strategy may thus be to move the useful signal to higher frequencies, where 1/f noise is negligible. In case of simple frequency translation, the chopper (493) input CHP₁ (403) may be a simple clock or sinewave with frequency f_{CHP1}. One skilled in the art will know how to perform proper frequency planning such that the useful signal (e.g. Vᵢₙ) is not destroyed.
The 1/f noise, voltage offset and other non-idealities are produced by circuits implementing the MSMPFF amplifier with chopping (400). The adders (414, 424, 434, 454, 464) are usually not implemented explicitly in circuits but are used as a way to model such inherent and unavoidable non-idealities of components (e.g. transconductors) used to implement MSMPFF amplifier with chopping. The signals on inputs (Vₒ₁, Vₒ₂, Vₒ₃, V_{f2}, V_{f3}) comprise such unavoidable (and modeled) non-idealities (e.g. 1/f noise, voltage offset, etc.) and are added (414, 424, 434, 454, 464) to the signal path.
The transconductor (415) with transconductance gₘ₁ converts voltage present on its input to proportional current iₘ₁ on its output. At node (494) the current iₘ₁ from transconductor (415) and iᵣ from noise reduction feedback loop (NRL) transconductor (498) converge (are summed). The output of transconductor (498) is such that iᵣ corresponds to inversion of the noise to be removed as much as possible. This way the summed signal current of iₘ₁+iᵣ at node (494) contains less noise (and/or other non-idealities) versus the case without the noise reduction loop NRL.
The (de)chopper (495) operation may include transformation of the signal on its input from a form that enabled removal or avoidance of non-idealities added by the circuit elements (in example, transconductor (415)) to an original form or to a form that is similar enough for purpose of the MSMPFF amplifier with chopping (400). For example, the (de)chopper (495) may implement frequency translation. The (de)chopper may be implemented for example as frequency mixer, as a simplified mixer with switches (producing also higher harmonics, which will be evident to one skilled in the art that are easily filtered), etc. One possible realization is disclosed in FIG. 10. The signal transformation performed by (de)chopper (495) may be selected based on various system and technology parameters including operation of chopper (493). In case of simple frequency translation, the (de)chopper (495) input CHP₂ (405) may be a simple clock or sinewave with frequency f_{CHP2}. One skilled in the art will know how to perform proper frequency planning such that the useful signal (e.g. Vᵢₙ) is sufficiently preserved.
The load Zₒ₁ (417) may be passive and generally (though not necessarily) complex, built as combination of resistive, capacitive or inductive impedances. The current flow through the load (417) to the (analog) ground defines the potential V₁ at node (494). Defined also by parasitics in real circuits the circuit exhibits a low pass filtering transfer function that may be taken advantage of in removing noise, images and other non-idealities at higher frequencies.
The NEC (497) operation may include extraction of the unwanted (non-idealities) signal components present in NEC (497) input which may be connected to different points in the circuit as shown in OPTION 4(b) and OPTION 4(c) connections. The extraction of non-idealities may be achieved by NEC (497) implementation as e.g. shown in FIG. 8 (810), FIG. 9 (900), FIG. 11 (1110), FIG. 1120, etc. In case of NEC (497) implementation as shown in FIG. 8 (810) the signal on the input of the NEC (811, FIG. 8) may be connected to the input of high pass filter HPF (812). The signal at point E (FIG. 8) at the input of the high pass filter HPF (812, FIG. 8) may be as shown in graph (820), FIG. 8. The output of the HPF (812, FIG. 8) at point F (FIG. 8) may be as shown in graph (830, FIG. 8). The output of HPF FIG. 8 (812) may be connected to the first input of the chopper (815, FIG. 8). Chopper (815, FIG. 8) may perform simple frequency translation. The chopper (815, FIG. 8) second input CHP (813, FIG. 8) may be a simple clock or sinewave with frequency f_{CHP}. One skilled in the art will know how to perform proper frequency planning such that the non-idealities to be removed are appropriately preserved. One possible implementation of chopper (815, FIG. 8) is the same as that of chopper (493). In such case it may be simplest if also the chopper (815, FIG. 8) input (813, FIG. 8) is the same as input (403) of the chopper (493). Other options will be clear to one skilled in the art and are part of the invention. For example, the chopper (815, FIG. 8) embedded in implementation of NEC (497) may implement frequency translation as shown in FIG. 8 from possible signal at its input at node F (FIG. 8) shown in graph (830, FIG. 8) to possible translated signal on connection G (FIG. 8) shown in graph (840, FIG. 8). The next step in extraction of unwanted non-idealities may be low pass filtering performed by a low pass filter LPF (817, FIG. 8). In example, the input to the low pass filter LPF (817, FIG. 8) may be signal on connection G (FIG. 8) shown in graph (840, FIG. 8) and the filtered signal with isolated non-idealities on the output H (FIG. 8) may be as shown in graph (850, FIG. 8). It may be important to realize that NEC (497) operates in a feedback loop. For this reason the suppression of unwanted non-idealities shown in FIG. 8 as the difference from signals with dashed lines to the signals with solid lines is achieved due to the feedback loop. Another possible realization of the NEC (497) that may have better characteristics in certain cases is shown in FIG. 9. The transconductor (498) with transconductance gₘᵣ converts voltage present on its input as may be shown in graph (850, FIG. 8) to negated proportional current iᵣ on its output. The negation (inversion) may be implemented with transconductor (498) or previously as part of NEC (497) operation or otherwise. What is important is that iᵣ when combined with iₘ₁ at node (494) closes the negative feedback loop and that the desired reduction/removal of non-idealities is achieved. It will be clear to one in the art how to achieve appropriate negation and how to design the negative feedback loop with appropriate stability.
The second main gain stage transconductor (425) with transconductance gₘ₂ may be connected to the input of current (de)chopper (495) followed by the load Zₒ₂ (427) connected toward (analog) ground. The input voltage of the transconductor (425) may include modeled non-idealities Vₒ₂ included by the addition (424). The voltage input of the transconductor (425) is converted to current iₘ₂ and combined with current output of the transconductor (455) of the first feed-forward gain stage (450). Current flowing through the node (496a) to the (de)chopper (495) first input may be iₘ₂+i_{f2}. The (de)chopper (495) may have a current input and current output. A possible realization may be the same as in case of a chopper voltage inputs and outputs. An example of (de)chopper realization and operation is shown on FIG. 10. Other possible realizations of (de)chopper (495) will be apparent to one skilled in the art. The (de)chopper (495) operation may include transformation of the signal on its input from a form that enabled removal or avoidance of non-idealities added by the circuit elements (in example, transconductor (415, 425)) to an original form or to a form that is similar enough for purpose of the MSMPFF amplifier with chopping (400). For example, the (de)chopper (495) may implement frequency translation that is an inverse of chopper (493) frequency translation.
The current flow through node (496a) and the load Zₒ₂ (427) connected toward (analog) ground define the voltage at node (496a) and the voltage at the input of NEC (497).
The third main gain stage (430), the first feed-forward stage (450) and the second feed-forward stage (460) operate as previously disclosed related to MSMPFF amplifier operation.
The output (408) of the MSMPFF amplifier with chopping (400) may have reduced non-idealities in comparison with corresponding MSMPFF amplifier without chopping.

### Notes

Described above is OPTION 4(b) with connection from node (496b) to input of the NEC (497). Possible also is OPTION 4(c) drawn with dashed lines with connection from node (496c) to input of NEC (497) instead of connection from node (496b) to input of NEC (497) in OPTION 4(b). Each of the options may come with their specific trade-offs analysis and implementation of which will be clear to one skilled in the art. Other options are also possible, as one skilled in the art would understand.
One purpose of feed-forward stages (450) and (460) may be to perform compensation for stability when MSMPFF amplifier with chopping (400) is operated in circuits with feedback. As previously described (e.g. see FIG. 1) the goal of such feed-forward structures may be to implement dominant or reduced pole transfer function of the MSMPFF amplifier with chopping.
Also possible are other connections of the feed-forward structures (450) and (460) as well as different number of them, as one skilled in the art would understand. These and their analysis will be clear from the disclosure to one skilled in the art. For example, the output of the second feed-forward stage (460) may be connected to node (496b) instead of node (496c). As an additional example the feed-forward stage (450) and/or (460) may not be implemented, etc. It will be clear to one skilled in the art from the disclosure how to implement and analyze such adaptation.
It will be clear to one skilled in the art that adders (414), (424), (434), (454) and (464) need not be explicitly added to the implemented circuits.

Higher order MSMPFF amplifiers (4th, 5th . . . ) with chopping possibilities may be constructed following the same principles as disclosed. Choppers and (de)choppers are placed according to the needs related to required SNR and power consumption. The chopping frequency depends on the application.

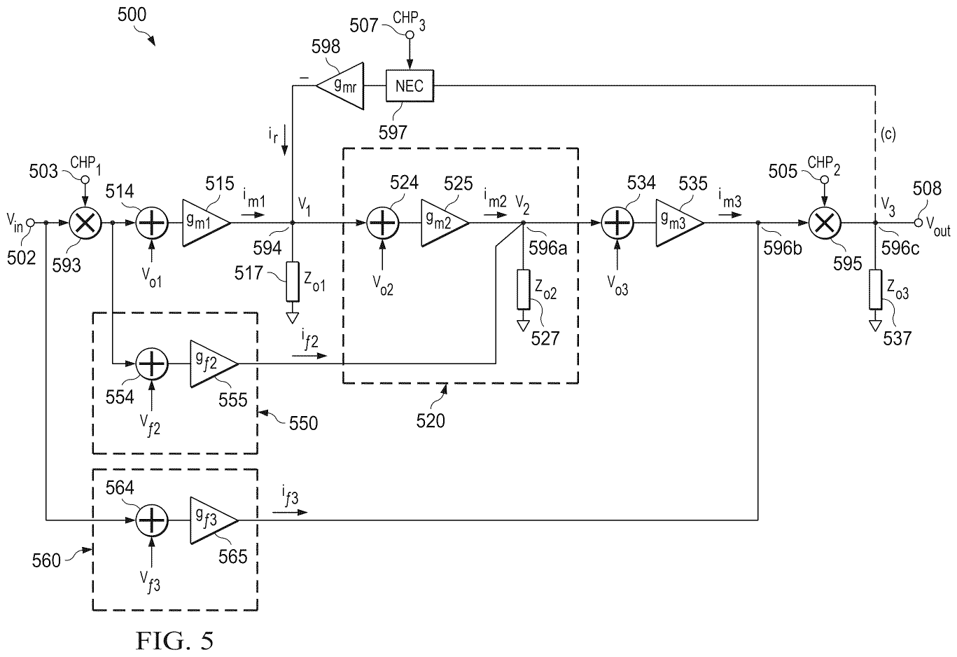

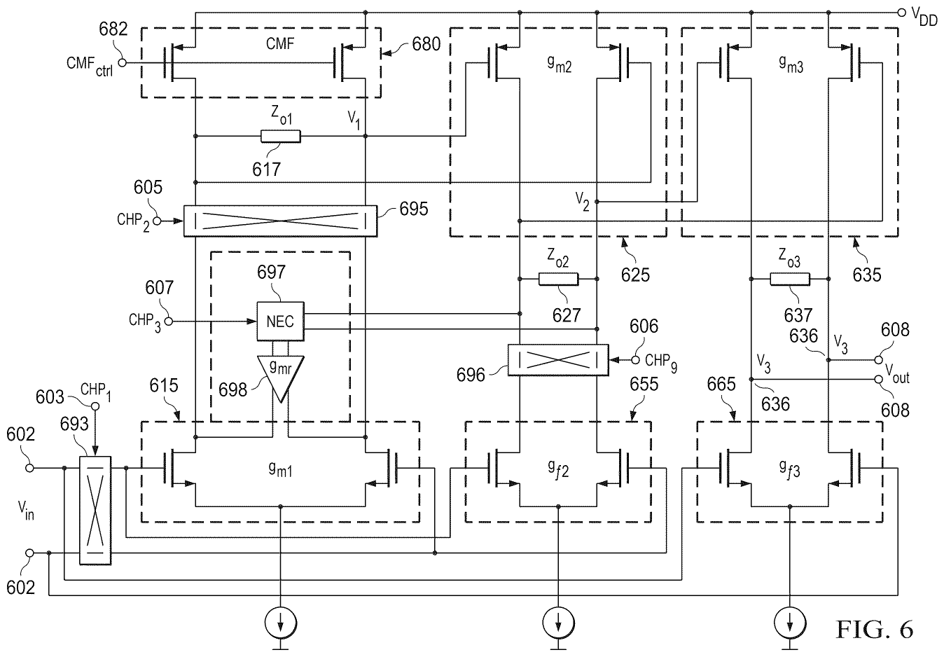

FIG. 5 shows alternative embodiments of MSMPFF chopping amplifier with different connections of chopping, (de) chopping and NEC circuits. The difference of the architecture shown in FIG. 5 compared to the architectures shown in FIGS. 2, 3 and 4 is that it reduces the nonideal contributions of all main gain stage transconductors gₘᵢ's and all feed-forward transconductors g_{fi}'s. The price paid for that is higher current consumption, because of the higher gₘᵢ's bandwidth requirements.

It will be clear to one skilled in the art how to apply the invention to MSMPFF amplifiers with different order and independently different number of feed-forward stages as well as to other similar circuits.

In one embodiment, the MSMPFF amplifier with chopping (500) as shown in FIG. 5 comprises:
An MSMPFF structure of 3rd order (see FIG. 1 for more detailed and generalized description of MSMPFF amplifier of n-th order and n−1 feed forward stages) with signal input (502) of MSMPFF amplifier with chopping (500), first chopping signal input CHP₁ (503), second chopping signal input CHP₂ (505), third chopping signal input CHP₃ (507) and MSMPFF amplifier with chopping (500) output (508). In addition, there are several “virtual” non-idealities VNI's (e.g. 1/f noise, voltage offset, etc.) inputs (Vₒ₁, Vₒ₂, Vₒ₃, V_{f2}, V_{f3}) that are added (514, 524, 534, 554, 564) to the signal path. The non-idealities inputs are “virtual” because they may not be explicitly designed and implemented by analogue designer yet the non-idealities are implicitly added to the signal path by the elements (usually mainly by transconductors) themselves.
The chopping signal sources CHP₁ (503), CHP₂ (505) or CHP₃ (507) may each output a signal with at least one frequency component. The chopping signal may be a clock with certain frequency, a sinewave or some other signal usually with one defining frequency. Often it may be beneficial that the chopping signal is approximately square (clock). Some or all of the chopping signal sources CHP₁ (503), CHP₂ (505), CHP₃ (507) may be related in some way (e.g. same signal source, square clock on one and same frequency sinewave on the other, they may be synchronized, etc.). It may be beneficial that some or all are the same or have the same origin (e.g. originate from the same source, are synchronized, etc.). Simplest and most power effective option may be for all chopping signals CHP₁ (503), CHP₂ (505) and CHP₃ (507) to be a clock with appropriately (as described previously) selected frequency. Chopper (593, see FIG. 9 for one possible implementation) with first input connected to input (502) of the MSMPFF amplifier with chopping (500) and second input connected to chopping signal source CHP₁ (503). The chopper (593) output is connected to adder (514) that may model addition of inherent first stage transconductor (515) 1/f noise, voltage offset and other non-idealities (Vₒ₁).
The output of the adder (514) is connected to the input of transconductor (515) with transconductance gₘ₁. The output of the transconductor (515) and the output of the transconductor (598) with transconductance gₘᵣ is connected to the current combining node (594).
The node (594) may be connected to (i) the output of the transconductor (515) with transconductance gₘ₁, (ii) the output of the transconductor (598) with transconductance gₘᵣ, (iii) the load Zₒ₁ (517) which is on the other side connected to the (analog) ground, and (iv) to the first input of the adder (524).

The adder (524) second input may model addition of inherent second main stage transconductor (525) 1/f noise, voltage offset, etc. non-idealities (Vₒ₂). The adder (524) output may be connected to the input of the second main gain transconductor (525) with transconductance gₘ₂.
The transconductor (525) output and the output of the transconductor (555) of the first feed-forward stage (550) with transconductance g_{f2} may be connected to the current combining node (596a).
The node (596a) connecting (i) the output of the second main gain stage (520) transconductor (525) with transconductance gₘ₂, (ii) the output of the first feed-forward stage (550) with transconductance g_{f2} transconductor (555), (iii) the load Zₒ₂ (527) which is on the other side connected to the (analog) ground and (iv) the first input of the added (534).
The adder (554) of the first feed-forward stage (550) with first input of the adder (554) connected to the output of the chopper (593), the adder (554) second input that may model addition of inherent second stage transconductor (555) 1/f noise, voltage offset, etc. non-idealities (V_{f2}) and adder (554) output that is connected to the input of the transconductor (555) with transconductance g_{f2}.
The adder (534) of the third main gain stage with first input of the adder (534) connected to the node (596a), the adder (534) second input that may model addition of inherent third stage transconductor (535) 1/f noise, voltage offset, etc. non-idealities (Vₒ₃) and adder (534) output that is connected to the input of the third main gain stage transconductor (535) with transconductance gₘ₃.
The node (596b) at potential V₃ₓ that may connect (i) the output of the transconductor (535), and (ii) the output of the transconductor (565) with transconductance g_{f3} of the second feed-forward stage (560), and (iii) the input of the chopper (595).
The adder (564) of the second feed-forward stage (560) with first input of the adder (564) connected to the output of the chopper (593), the adder (564) second input that may model addition of inherent third stage transconductor (565) 1/f noise, voltage offset, etc. non-idealities (V_{f3}) and adder (564) output that is connected to the input of the transconductor (565) with transconductance g_{f3}.
The transconductor (565) with transconductance g_{f3} and its output connected the node (596b) thus closing the feed-forward connection.
The (de)chopper (595) with first input connected to the node (596b). The second input of the (de)chopper (595) may be connected to chopping signal source CHP₂ (505). The chopping signal source CHP₂ (505) may output a signal with at least one frequency component.
The output of the (de)chopper (595) is connected to the node (596c) at potential V₃. In case of OPTION 5(c) the node (596c) may be connected (i) to the input of the NEC (597), and (ii) to the load Zₒ₃ (537) towards the ground.
The NEC (597) may have an additional (second) input (507) which is the chopping signal source CHP₃ input (507). The output of NEC (597) is connected to the input of the transconductor (598) with transconductance gₘᵣ. While all transconductors including gₘᵣ produce non-idealities, these are not modeled here as they are usually suppressed in comparison to Vₒ₁ and since they are equivalently present regardless of the NEC connection may be thus, if needed, modeled as being as part of Vₒ₁. The transconductor (598) output is connected to the node (594) closing the negative feedback of the NRL loop which reduces the non-idealities. The negative feedback may be achieved by b.g. explicit inversion in the NRL, by appropriate connections in case of differential circuits or otherwise.
The output Vₒᵤₜ (508) of the MSMPFF amplifier with chopping (500) connected with node (596c).

One embodiment of the operation of the MSMPFF amplifier with chopping (500) of FIG. 5 is as follows:

The input signal Vᵢₙ is applied to the input (502) of the MSMPFF amplifier with chopping (500).
Chopper (593) operation may include transformation of the signal on its input into a form that enables later removal or avoidance of non-idealities added by the downstream elements (in example, transconductor (515)). For example, the chopper (593) may implement frequency translation of the possible input signal Vᵢₙ (502). The chopper may be implemented for example as frequency mixer, as a simplified mixer with switches (producing also higher harmonics, which will be evident to one skilled in the art that are easily filtered), etc. One possible realization is disclosed in FIG. 10. The signal transformation performed by chopper (593) may be selected based on various system and technology parameters. As an example, the 1/f noise is by far dominant noise contribution at lower (up-to approx. order of some MHz) when implementing circuits (e.g. transconductors) in CMOS technology. The strategy may thus be to move the useful signal to higher frequencies, where 1/f noise is negligible. In case of simple frequency translation, the chopper (593) input CHP₁ (503) may be a simple clock or sinewave with frequency f_{CHP1}. One skilled in the art will know how to perform proper frequency planning such that the useful signal (e.g. Vᵢₙ) is not destroyed.
The 1/f noise, voltage offset and other non-idealities are produced by circuits implementing the MSMPFF amplifier with chopping (500). The adders (514, 524, 534, 554, 564) are usually not implemented explicitly in circuits but are used as a way to model such inherent and unavoidable non-idealities of components (e.g. transconductors) used to implement MSMPFF amplifier with chopping. The signals on inputs (Vₒ₁, Vₒ₂, Vₒ₃, V_{f2}, V_{f3}) comprise such unavoidable (and modeled) non-idealities (e.g. 1/f noise, voltage offset, etc.) and are added (514, 524, 534, 554, 564) to the signal path.
The transconductor (515) with transconductance gₘ₁ converts voltage present on its input to proportional current iₘ₁ on its output. At node (594) the current iₘ₁ from transconductor (515) and iᵣ from noise reduction feedback loop (NRL) transconductor (598) converge (are summed). The output of transconductor (598) is such that iᵣ corresponds to inversion of the noise to be removed as much as possible. This way the summed signal current of iₘ₁+iᵣ at node (594) contains less noise (and/or other non-idealities) versus the case without the noise reduction loop NRL.
The (de)chopper (595) operation may include transformation of the signal on its input from a form that enabled removal or avoidance of non-idealities added by the circuit elements (in example, transconductor (515)) to an original form or to a form that is similar enough for purpose of the MSMPFF amplifier with chopping (500). For example, the (de)chopper (595) may implement frequency translation. The (de)chopper may be implemented for example as frequency mixer, as a simplified mixer with switches (producing also higher harmonics, which will be evident to one skilled in the art that are easily filtered), etc. One possible realization is disclosed in FIG. 10. The signal transformation performed by (de)chopper (595) may be selected based on various system and technology parameters including operation of chopper (593). In case of simple frequency translation, the (de)chopper (595) input CHP₂ (505) may be a simple clock or sinewave with frequency f_{CHP2}. One skilled in the art will know how to perform proper frequency planning such that the useful signal (e.g. Vᵢₙ) is sufficiently preserved.
The load Zₒ₁ (517) may be passive and generally (though not necessarily) complex, built as combination of resistive, capacitive or inductive impedances. The current flow through the load (517) to the (analog) ground defines the potential V₁ at node (594). Defined also by parasitics in real circuits the circuit exhibits a low pass filtering transfer function that may be taken advantage of in removing noise, images and other non-idealities at higher frequencies.
The NEC (597) operation may include extraction of the unwanted (non-idealities) signal components present in NEC (597) input which may be connected to different points in the circuit as shown in OPTION 5(c) connections. The extraction of non-idealities may be achieved by NEC (597) implementation as e.g. shown in FIG. 8 (810), FIG. 9 (900), FIG. 11 (1110), FIG. 1120, etc. In case of NEC (597) implementation as shown in FIG. 8 (810) the signal on the input of the NEC (811, FIG. 8) may be connected to the input of high pass filter HPF (812). The signal at point E (FIG. 8) at the input of the high pass filter HPF (812, FIG. 8) may be as shown in graph (820), FIG. 8. The output of the HPF (812, FIG. 8) at point F (FIG. 8) may be as shown in graph (830, FIG. 8). The output of HPF FIG. 8 (812) may be connected to the first input of the chopper (815, FIG. 8). Chopper (815, FIG. 8) may perform simple frequency translation. The chopper (815, FIG. 8) second input CHP (813, FIG. 8) may be a simple clock or sinewave with frequency f_{CHP}. One skilled in the art will know how to perform proper frequency planning such that the non-idealities to be removed are appropriately preserved. One possible implementation of chopper (815, FIG. 8) is the same as that of chopper (593). In such case it may be simplest if also the chopper (815, FIG. 8) input (813, FIG. 8) is the same as input (503) of the chopper (593). Other options will be clear to one skilled in the art and are part of the invention. For example, the chopper (815, FIG. 8) embedded in implementation of NEC (597) may implement frequency translation as shown in FIG. 8 from possible signal at its input at node F (FIG. 8) shown in graph (830, FIG. 8) to possible translated signal on connection G (FIG. 8) shown in graph (840, FIG. 8). The next step in extraction of unwanted non-idealities may be low pass filtering performed by a low pass filter LPF (817, FIG. 8). In example, the input to the low pass filter LPF (817, FIG. 8) may be signal on connection G (FIG. 8) shown in graph (840, FIG. 8) and the filtered signal with isolated non-idealities on the output H (FIG. 8) may be as shown in graph (850, FIG. 8). It may be important to realize that NEC (597) operates in a feedback loop. For this reason the suppression of unwanted non-idealities shown in FIG. 8 as the difference from signals with dashed lines to the signals with solid lines is achieved due to the feedback loop. Another possible realization of the NEC (597) that may have better characteristics in certain cases is shown in FIG. 9.
The transconductor (598) with transconductance gₘᵣ converts voltage present on its input as may be shown in graph (850, FIG. 8) to negated proportional current iᵣ on its output. The negation (inversion) may be implemented with transconductor (598) or previously as part of NEC (597) operation or otherwise. What is important is that iᵣ when combined with iₘ₁ at node (594) closes the negative feedback loop and that the desired reduction/removal of non-idealities is achieved. It will be clear to one in the art how to achieve appropriate negation and how to design the negative feedback loop with appropriate stability.
The second main gain stage (520), the first feed-forward stage (550) and the second feed-forward stage (560) operate as previously disclosed related to MSMPFF amplifier operation.
The output of the second main gain stage (520) is connected to the first input of adder (534) which purpose may be the modeling of the e.g. transconductor (535) non-idealities.
The transconductor (535) with transconductance gₘ₃ may be connected to the input of current (de)chopper (595) followed by the load Zₒ₃ (537) connected toward (analog) ground. The voltage input of the transconductor (535) may include modeled non-idealities Vₒ₃ included by the addition (534). The input voltage of the transconductor (535) is converted to current iₘ₃ and combined with current output of the transconductor (565) of the second feed-forward gain stage (560). Current flowing to the input of the (de)chopper (595) first input may be iₘ₃+i_{f3}. The (de)chopper (595) may have a current input and current output. A possible realization may be the same as in case of a chopper voltage inputs and outputs. An example of (de)chopper realization and operation is shown on FIG. 10. Other possible realizations of (de)chopper (595) will be apparent to one skilled in the art. The (de)chopper (595) operation may include transformation of the signal on its input from a form that enabled removal or avoidance of non-idealities added by the circuit elements—in example, transconductors (515, 525, 535, 555, 565)—to an original form or to a form that is similar enough for purpose of the MSMPFF amplifier with chopping (500). For example, the (de)chopper (595) may implement frequency translation that is an inverse of chopper (593) frequency translation.
The current iₘ₃+i_{f3} flows through chopper (595) to the load Zₒ₃ (537) toward (analog) ground and defines the voltage at node (596c) and the voltage at the input of NEC (597).
The output (508) of the MSMPFF amplifier with chopping (500) may have reduced non-idealities in comparison with corresponding MSMPFF amplifier without chopping.

### Notes

One purpose of feed-forward stages (550) and (560) may be to perform compensation for stability when MSMPFF amplifier with chopping (500) is operated in circuits with feedback. As previously described (e.g. see FIG. 1) the goal of such feed-forward structures may be to implement dominant or reduced pole transfer function of the MSMPFF amplifier with chopping.
Possible are other connections of the feed-forward structures (550) and (560) as well as different number of them. These and their analysis will be clear from the disclosure to one skilled in the art. As an example the feed-forward stage (550) and/or (560) may not be implemented, etc. It will be clear to one skilled in the art from the disclosure how to implement and analyze such adaptation.
It will be clear to one skilled in the art that adders (514), (524), (534), (554) and (564) need not be explicitly added to the implemented circuits.

Higher order MSMPFF amplifiers (4th, 5th . . . ) with chopping possibilities may be constructed following the same principles as disclosed. Choppers and (de)choppers are placed according to the needs related to required SNR and power consumption. The chopping frequency depends on the application.

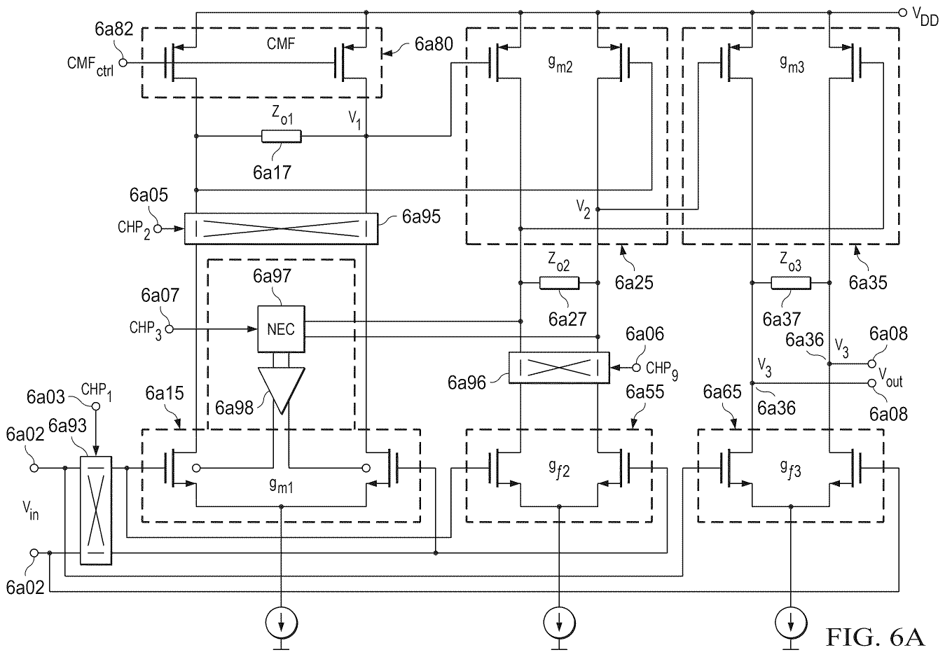

FIG. 6 shows one embodiment of a circuit implementation of the MSMPFF amplifier with chopping (300) OPTION 3(b) presented in FIG. 3.

One embodiment of the MSMPFF amplifier with chopping circuit implementation (600) of FIG. 6 comprises the following components matched with corresponding components of the circuit presented in FIG. 3, OPTION 3(b):
Input Vᵢₙ (602) of the MSMPFF amplifier with chopping (600) corresponding to input (302)
Chopper (693) corresponding to chopper (393)
First main stage transconductor (615) with transconductance gₘ₁ corresponding to transconductor (315)
Second main stage transconductor (625) with transconductance gₘ₂ corresponding to transconductor (325)
Third main stage transconductor (635) with transconductance gₘ₃ corresponding to transconductor (335)
Load Zₒ₁ (617) following first main stage transconductor (615) corresponding to load Zₒ₁ (317)
Load Zₒ₂ (627) following second main stage transconductor (625) corresponding to load Zₒ₂ (327)
Load Zₒ₃ (637) following third main stage transconductor (635) corresponding to load Zₒ₁ (337)
NEC (697) corresponding to NEC (397)
NRL transconductor (698) with transconductance gₘᵣ corresponding to transconductor (398)
First feed-forward transconductor (655) with transconductance g_{f2} corresponding to transconductor (355)
Second feed-forward transconductor (665) with transconductance g_{f3} corresponding to transconductor (365)
(De)chopper (695) corresponding to (de)chopper (395) and (de)chopper (696) corresponding to (de)chopper (396).
Output Vₒᵤₜ (608) of the MSMPFF amplifier with chopping (600) corresponding to output (308).
The common mode feedback (CMF) transistors (680) not shown in the FIG. 3.
The NEC (697) and NRL transconductor (698) with transconductance gₘᵣ are not shown as transistor circuits for simplicity. One possible implementation of the NEC (697) as transistor circuits is shown in FIG. 9.

One embodiment of the operation of the MSMPFF amplifier with chopping circuit implementation (600) shown in FIG. 6 is as follows:
Is as described related to FIG. 3 OPTION 3(b).
The common mode feedback circuit (680) operation is as follows. The drains of PMOS transistors (680) are connected to the chopper (695) and to impedance (load) Zₒ₁ (617). They operate as current sources that may source appropriate currents to first main gain stage transconductor (615) with transconductance gₘ₁ and PMOS transistors (680) may also contribute its own conductance gds (may be usually negligible) to the load Zₒ₁ (617) impedance. With the control signal CMFctrl (682) that may be connected to the gates of PMOS transistors (680) one may control the common mode voltage V1 (V1p and V1n) using the CMF (common Mode feedback) circuit through transistors (680). CMF circuit is, for clarity, not included in the figure however it will be apparent to one skilled in the art.
One purpose of CMF (680) circuit will be apparent to one skilled in the art.

### Note

As already disclosed the non-idealities are modelled by Vₒᵢ and V_{fi} that are added to the signal using adders (314, 324, 334, 354, 364). They are usually not implemented (explicitly) in the circuits. However, as it will be apparent to one skilled in the art the modeled non-idealities (Vₒ₁, Vₒ₂, Vₒ₃, V_{f2}, V_{f3}) are still present and added to the signals due to internal non-ideal operation of the circuits shown in FIG. 6.
It will be apparent to one skilled in the art how the differential circuits in FIG. 6 correspond to the circuits shown in FIG. 3, OPTION 3(b).

FIG. 6A shows a variation of the amplifier implementation shown in FIG. 6, where a voltage amplifier controls the body bias terminals of the first main gain stage transconductor. Using modern FDSOI technology to build high frequency N-path filters, mixers, ADCs, DAC's, and HF transceivers makes it possible to increase the frequency of operation significantly comparing to bulk CMOS technologies. In addition, the power consumption can be reduced significantly compared to electronic systems built with older bulk CMOS technologies.

The speed of operation of digital as well as mixed signal circuits is dependent on the speed of basic transistors used (for example super low threshold voltage transistors), and clever use of reverse body bias, which makes possible to add additional functionality. For example, this can speed up the operation of digital circuits and at the same time reduce the power consumption due to reduced sub-threshold leakage and small parasitic capacitances. For analog and mixed signal circuits, compared to bulk CMOS technologies, many additional functionalities are possible due to the “fourth terminal”.

FIG. 6A shows an example how this may be achieved. The circuit in FIG. 6A is identical to the one in FIG. 6, with the exception of transconductor (FIG. 6, 698) converting voltage on its input to corresponding current on its output. The transconductor gₘᵣ (FIG. 6, 698) in the FIG. 6A is replaced by voltage amplifier (6a98) that controls body bias terminals of transistors implementing transconductor gₘ₁ (6a15). The other similar usages of the body bias terminal are part of the invention and their usage and implementation will be apparent to one skilled in the art.

FIG. 7 shows possible signal diagrams at different points of the MSMPFF amplifier with chopping (200) circuit disclosed in FIG. 2:
Possible input signal Vᵢₙ (202) at node A (FIG. 2) is shown in graph (710, FIG. 7)
Possible translated signal on wire B (FIG. 2) is shown in graph (720, FIG. 7)
Addition of possible non-idealities modeled on wire C (FIG. 2) is shown in graph (730, FIG. 7)
Possible current iₘ₁ from transconductor (FIG. 2, 215) and iᵣ from noise reduction feedback loop transconductor (FIG. 2, 298) combine at node D (FIG. 2, 294) as shown with full line on graph (740, FIG. 7)
Possible (e.g. back) translated (de) chopped signal at node E (FIG. 2) is shown in graph (750, FIG. 7).
Possible output Vₒᵤₜ (FIG. 2, 208) of the MSMPFF amplifier with chopping (FIG. 2, 200) with reduced non-idealities is shown at node X in a graph (760, FIG. 7).

FIG. 8: shows one embodiment of NEC (non-idealities extraction circuit) implementation. In one embodiment, NEC (810) may comprise:
Possible Vᵢₙ input (811), shown at point E on graph (820) may be connected to the high pass filter (HPF) (812). The output of the HPF (812) with possible signal shown at point F on graph (830).
The output of the HPF (812) connected to the chopper (815) first input. Second Chopper (815) input CHP (813) may be a simple clock or sinewave or other appropriate signal.
The possible output of the chopper (815) may be as shown in point G on graph (840). The output of the chopper (815) may be connected to the input of the low pass filter LPF (817).
The low pass filter LPF (817) output is the output (819) Vₒᵤₜ of the NEC (810) and may be as shown in graph 850.

One purpose of NEC (810) is to extract non-idealities so that they can be removed (subtracted) as part of NRL operation:
The extraction of non-idealities may be achieved by NEC (810) implementation as shown in FIG. 8 (810), where the possible signal on the input (811) of the NEC (810) at point E may be as shown in diagram (820). The input (811) of the NEC (810) may be connected to the HPF (812).
The HPF (812) has behavior of high pass filter which suppresses the low frequency components. The possible signal at point F which is at the output of HPF (812) may be as shown in diagram (830). The signal at the output of HPF (812) with suppressed low frequencies enters chopper (815).
Chopper (815) may perform frequency translation. The chopper (815) second input CHP (813) may be a simple clock or sinewave with frequency f_{CHP}. One skilled in the art will know how to perform proper frequency planning such that the non-idealities to be removed are appropriately preserved.
One possible implementation of chopper (815) is the same as that of chopper shown in FIG. 9. Other options will be clear to one skilled in the art and are part of the invention. For example, the chopper (815) embedded in implementation of NEC (810) may implement frequency translation as shown in FIG. 8 from possible signal at its input at node F (FIG. 8) shown in graph (830) to possible translated signal on connection G (FIG. 8) shown in graph (840). The next step in extraction of unwanted non-idealities may be low pass filtering performed by a low pass filter (817).
In example, the input to the low pass filter (817, FIG. 8) may be signal on connection G (FIG. 8) shown in graph (840) and the filtered signal with isolated non-idealities on the output H (FIG. 8) may be as shown in graph (850). It may be important to realize that NEC (810) may operate in a (negative) feedback loop.

One example of NEC (810) realization that may have better characteristics in certain cases is shown in FIG. 9. Specifically, the HPF (812, FIG. 8) may be implemented as switched capacitor circuit (910 FIG. 9). The chopper (815, FIG. 8) may correspond to chopper (934, FIG. 9). A more detailed possible implementation of chopper is shown in FIG. 10. The LPF (817, FIG. 8) may be implemented as circuit on the right side of chopper (980, FIG. 9). Other implementations are possible, as one skilled in the art would understand.

### Note

It will be apparent to one skilled in the art how to implement NEC (810) with current input and current output. The embodiments with such current input and current output NEC (810) are part of the invention.

One purpose of the NEC is to extract the ripple caused by chopping the VNI using as small power as possible in as small area as possible and with as small added non-idealities (e.g. offset voltage and 1/f noise). One possible way to do that is a differential version of NEC (900) detailed in FIG. 9. It is a switched capacitor circuit that operates as fully differential circuit and is explained below.

In one embodiment, the NEC (900) of FIG. 9 comprises:
Differential input Vᵢₙₚ and Vᵢₙₙ (902) connected to switched capacitors Cs1 (912) and Cs2 (914) left side. The right side of the capacitors Cs1 (912) and Cs2 (914) is connected to the node (916) and node (918) respectively.
The switch S1 (922) is connected to Cs1 (912) and input to one differential input of the chopper (934) at node (916).
The switch S2 (924) is connected to Cs2 (914) and input to the other differential input of the chopper (934) at node (918).
The differential outputs of the chopper (934) are connected to node (936) and node (938). The second input to the chopper is chopping signal (932).
The node (936) connects one differential output of chopper (934) with left side of capacitor Caz1 (942) and left side of capacitor Cint1 (952).
The node (938) connects the other differential output of chopper (934) with the left side of capacitor Caz2 (944) and left side of capacitor Cint2 (954).
The right side of capacitor Cint1 (952) is connected to node (976).
The right side of capacitor Cint2 (954) is connected to node (978).
The right side of capacitor Caz1 (942) is connected to node (946).
The right side of capacitor Caz2 (944) is connected to node (948).
The node (946) is connected to the left side of the switch S3 (956) and to one differential input of the S/H amplifier (960).
The node (948) is connected to the left side of the switch S4 (958) and to the other differential input of the S/H amplifier (960).
The right side of the switch S3 (956) is connected to the node (966).
The right side of the switch S4 (958) is connected to the node (968).
The differential outputs of the S/H amplifier (960) are connected to node (966) and (968).
The node (966) is connected to the left side of switch S5 (972).
The node (968) is connected to the left side of switch S6 (974).
The right side of switch S5 (972) is connected to node (976).
The right side of switch S6 (974) is connected to node (978).
The differential output (908) is connected to node (976) and node (978).

In one embodiment, the NEC (900) of FIG. 9 operates as follows:

Cs1 (912) and Cs2 (914) are connected to Vᵢₙₚ and Vᵢₙₙ inputs (902) on the left side. During φ2 right sides of Cs1 (912) and Cs2 (914) are grounded, therefore Qcs1=Vᵢₙₚ·Cs1 and Qcs2=Vᵢₙₙ·Cs2. At the same time the S/H amplifier is in unity gain configuration since S3 (956) and S4 (958) are turned on. Offset voltage and 1/f noise of the S/H amplifier are stored in Caz1 (942) and Caz2 (944). At the same time the capacitors Cint1 (952) and Cint2 (954) hold previous value of the result and thus hold the output voltages Vₒᵤₜₚ and Vₒᵤₜₙ on the output (908) constant.

During φ1 switches S1 (922), S2 (924), S3 (956), and S4 (958) are opened while switches S5 (972) and S6 (974) are closed and thus rearrange the amplifier (960) from unity gain to charge amplifier. The charges through Cs1 (912) and Cs2 (914) are proportional to derivative of Vᵢₙₚ and Vᵢₙₙ. These charges through Cs1 (912) and Cs2 (914) are transferred to Cint1 (952) and Cint2 (954) changing the voltages Vₒᵤₜₚ and Vₒᵤₜₙ at the output (908). The offset and 1/f noise of the S/amplifier have been subtracted and thus eliminated from the resulting output (908).

The frequency of the clocks f (φ1, φ2) is half of CHP (932). A chopper (934) circuit that runs with CHP clock makes both derivatives of Vᵢₙₚ and Vᵢₙₙ during time T_{CHP}=1/f_{CHP} with appropriate sign and thus the voltage stored in capacitors Cint1 (952) and Cint2 (954) is constantly available during the phase of φ1 and remains stored during φ1.

FIG. 10 shows one embodiment of a realization of differential chopper (1000) with transistors. The differential (de)chopper implementation may be the same as of the differential chopper (1000).

The differential chopper (1000) comprises:
The differential input of chopper (1000) comprising INP (1012) and INN (1014).
The INP (1012) connected to node (1016). Also connected to node (1016) are the source of NMOS transistor (1022) and the drain of the PMOS transistor (1024).
The gate of the NMOS transistor (1022) connected to signal input x.
The gate of the PMOS transistor (1024) connected to signal input x.
The drain of the NMOS transistor (1022) connected to the source of PMOS transistor (1024) and to the node (1042)
Additionally connected to node (1016) are the source of the NMOS transistor (1026) and the drain of the PMOS transistor (1028).
The gate of the NMOS transistor (1026) connected to signal input y.
The gate of the PMOS transistor (1028) connected to signal input y.
The drain of the NMOS transistor (1026) connected to the source of PMOS transistor (1028) and to the node (1044).
The INN (1014) connected to node (1018). Also connected to node (1018) are the source of NMOS transistor (1032) and the drain of the PMOS transistor (1034).
The gate of the NMOS transistor (1032) connected to signal input y.
The gate of the PMOS transistor (1034) connected to signal input y.
The drain of the NMOS transistor (1032) connected to the source of PMOS transistor (1034) and to the node (1042).
Additionally connected to node (1018) are the source of the NMOS transistor (1036) and the drain of the PMOS transistor (1038).
The gate of the NMOS transistor (1036) connected to signal input x.
The gate of the PMOS transistor (1038) connected to signal input x.
The drain of the NMOS transistor (1036) connected to the source of PMOS transistor (1038) and to the node (1044).
The output OUTP (1092) connected to the node (1042) and the output OUTN (1094) connected to the node (1044).

In one embodiment, the differential chopper (1000) of FIG. 10 operates in the following way:
The control signals x and y are connected to the gates of NMOS transistors, while x̅ and y̅ are connected to gates of PMOS transistors. The control signals x and y (also x̅ and y̅) may be digital signals that may have a frequency of CHP.
The control signals x and y (also x̅ and y̅) may be non-overlapping signals meaning that they are never both 1 at the same time, where it may be beneficial for the non-overlapping time to be as short as possible.
When x=1, and y=0, input signal INP (1012) is connected to OUTP (1092) while INN (1014) is connected to OUTN (1094).
When x=0, and y=1, input signal INP (1012) is connected to OUTN (1094) while INN (1014) is connected to OUTP (1092).
The operation thus multiplies the differential input signal with +/−1 causing frequency translation of the input signals.

FIG. 11 shows alternative realizations of an NEC (non-idealities extraction circuit). Depending on required quality of the output and other requirements it may be beneficial to use the NEC architectures as described here.

In one embodiment, the NEC (1110) of FIG. 11 may comprise:

Possible Vᵢₙ input (1111) may be connected to the high pass filter (HPF) (1112).

The output of the HPF (1112) connected to the chopper (1115) first input. Second Chopper (1115) input CHP (1113) may be a simple clock or sinewave or other appropriate signal.

The chopper (1115) output may be the output (1119) Vₒᵤₜ of the NEC (1110).

One purpose of NEC (1110) is to extract non-idealities so that they can be removed (subtracted) as part of NRL operation:
The extraction of non-idealities may be achieved by NEC (1110) where the possible signal on the input (1111) comprises useful signal at low frequencies and non-idealities at high frequencies. The input (1111) of the NEC (1110) may be connected to the HPF (1112).
The HPF (1112) has behavior of a high pass filter which suppresses the low frequency components. The signal at the output of HPF (1112) has low frequency signals suppressed.
Chopper (1115) may perform frequency translation. The chopper (1115) second input CHP (1113) may be a simple clock or sinewave with frequency f_{CHP}. One skilled in the art will know how to perform proper frequency planning such that the non-idealities to be removed are appropriately preserved.
One possible implementation of chopper (1115) is the same as that of chopper shown in FIG. 9. Other options will be clear to one skilled in the art and are part of the invention. For example, the chopper (1115) embedded in implementation of NEC (1110) may implement frequency translation such that non-idealities are translated to low frequencies.

One example of possible NEC (1110) realization that may have better characteristics may comprise the switched capacitor circuit (910, FIG. 9) implementation of HPF (1110) operation. The chopper (1115) may correspond to chopper (934, FIG. 9). A more detailed possible implementation of chopper is shown in FIG. 10. Other implementations are possible.

In one embodiment, the NEC (1120) of FIG. 11 may comprise:
Possible Vᵢₙ input (1121) may be connected to the first chopper (1125) input.
Second Chopper (1125) input CHP (1123) may be a simple clock or sinewave or other appropriate signal.
The possible output of the chopper (1125) may be an input to LPF (1127)
The LPF (1127) output is the output (1129) Vₒᵤₜ of the NEC (1120).

One purpose of NEC (1120) is to extract non-idealities so that they can be removed (subtracted) as part of NRL operation:
The extraction of non-idealities may be achieved by NEC (1120) where the possible signal on the input (1121) comprises useful signal at low frequencies and non-idealities at high frequencies. The input (1121) of the NEC (1120) may be connected to the first input of the chopper (1125).
Chopper (1125) may perform frequency translation. The chopper (1125) second input CHP (1123) may be a simple clock or sinewave with frequency f_{CHP}. One skilled in the art will know how to perform proper frequency planning such that the non-idealities to be removed are appropriately preserved.
One possible implementation of chopper (1125) is the same as that of chopper shown in FIG. 9. Other options will be clear to one skilled in the art and are part of the invention. For example, the chopper (1125) embedded in implementation of NEC (1120) may implement frequency translation such that non-idealities are translated to low frequencies.
The LPF (1127) has behavior of a low pass filter which suppresses the high frequency components. The signal at the output of LPF (1127) has high frequency signals suppressed.

One example of possible NEC (1120) realization that may have better characteristics may be implemented as circuit on the right side of chopper (980, FIG. 9). The chopper (1125) may correspond to chopper (934, FIG. 9). A more detailed possible implementation of chopper is shown in FIG. 10.

Following are notes that are applicable to all of the embodiments described herein).

Some of embodiments may translate useful signals to other frequencies, or, may translate unwanted signals to other frequencies as may be convenient in particular use of the MSMPFF amplifier with chopping. For example, the MSMPFF amplifier frequency planning may be performed jointly with sigma delta ADC frequency planning is a way that is more optimal on the system level. Described are gain stages with transconductors. This may be convenient in most usual cases. However, in certain cases it may be beneficial to design circuits with current input and output, using transimpedance elements instead of transconductors. These are part of the invention. It will be apparent to one skilled in the art how to convert described circuits then transimpedance gain stages are used instead of transconductance gain stages.

The disclosed circuits (including different architectures of the MSMPFF amplifier with chopping) may be implemented using single ended and/or differential signal paths (or combination thereof). The tradeoffs may depend on particular circumstances and will be apparent to one skilled in the art. Many variations, optimizations and alternative implementations applicable to conventional decimation and other digital signal processing are possible. These will be apparent to one skilled in the art and may all be applicable to invention. It will be clear to one skilled in the art that all the circuits may be implemented as single ended or as differential.

Although the invention has been described with respect to specific embodiments thereof, these embodiments are merely illustrative, and not restrictive of the invention as a whole. Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention.

Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Software implementing embodiments disclosed herein may be implemented in suitable computer-executable instructions that may reside on a computer-readable storage medium. Within this disclosure, the term “computer-readable storage medium” encompasses all types of data storage medium that can be read by a processor. Examples of computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, hosted or cloud-based storage, and other appropriate computer memories and data storage devices.

Those skilled in the relevant art will appreciate that the invention can be implemented or practiced with other computer system configurations including, without limitation, multi-processor systems, network devices, mini-computers, mainframe computers, data processors, and the like. The invention can be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks).

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention. At least portions of the functionalities or processes described herein can be implemented in suitable computer-executable instructions. The computer-executable instructions may reside on a computer readable medium, hardware circuitry or the like, or any combination thereof.

Any suitable programming language can be used to implement the routines, methods or programs of embodiments of the invention described herein, including C, C++, Java, JavaScript, HTML, or any other programming or scripting code, etc. Different programming techniques can be employed such as procedural or object oriented. Other software/hardware/network architectures may be used. Communications between computers implementing embodiments can be accomplished using any electronic, optical, radio frequency signals, or other suitable methods and tools of communication in compliance with known network protocols.

As one skilled in the art can appreciate, a computer program product implementing an embodiment disclosed herein may comprise a non-transitory computer readable medium storing computer instructions executable by one or more processors in a computing environment. The computer readable medium can be, by way of example only but not by limitation, an electronic, magnetic, optical or other machine readable medium. Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices.

Particular routines can execute on a single processor or multiple processors. Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. Functions, routines, methods, steps and operations described herein can be performed in hardware, software, firmware or any combination thereof.

It will also be appreciated that one or more of the elements depicted in the drawings/figures can be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the meaning of “in” includes “in” and “on” unless the context clearly dictates otherwise.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Generally then, although the invention has been described with respect to specific embodiments thereof, these embodiments are merely illustrative, and not restrictive of the invention. Rather, the description is intended to describe illustrative embodiments, features and functions in order to provide a person of ordinary skill in the art context to understand the invention without limiting the invention to any particularly described embodiment, feature or function, including any such embodiment feature or function described. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

What is claimed is:

1. A distributed beamforming system comprising a plurality of chiplets, wherein the system collectively comprises:
a plurality of Analog-to-Digital Converters (ADCs) configured to sample antenna signals;
digital beamforming logic (DBFL);
a plurality of low power wireless short-range transmitters (WTXs), configured to broadcast a digital bitstream corresponding to sampled signals;
a plurality of low power wireless short-range receivers (WRXs), configured to receive broadcast digital bitstreams from other chiplets;
wherein the ADCs and the DBFL are distributed across the plurality of chiplets;
wherein sampled ADC bitstreams are distributed between chiplets wirelessly; and
wherein the DBFL is configured to compute beamformed channels using at least the wirelessly received digital bitstreams from other chiplets.

2. The distributed beamforming system of claim 1, wherein the plurality of low power wireless short-range transmitters (WTXs) are configured to modulate the digital bitstream to high frequencies to enable very compact antennae dimensions.

3. The distributed beamforming system of claim 1, wherein the complexity of required interconnectivity scales linearly with the number of wireless transmitters and wireless receivers, as opposed to quadratically with the number of data sources and data sinks when using non-broadcasting physical wired connections.

4. The distributed beamforming system of claim 1, wherein at least one chiplet is a single die scalable digital beamforming solution integrating an ADC, DBFL, a WTX, and a WRX.

5. The distributed beamforming system of claim 1, wherein the plurality of chiplets includes ADC chiplets comprising an ADC and a WTX, and DBFL chiplets comprising a WRX and DBFL.

6. The distributed beamforming system of claim 1, wherein the sampled ADC bitstreams are transmitted by the WTXs in an inherently broadcast manner such that a signal from one transmit antenna may be received by any number of receive antennae and receivers in range.

7. The distributed beamforming system of claim 1, wherein the WTXs utilize on-die antennae to transmit the digital bitstream.

8. The distributed beamforming system of claim 1, wherein the DBFL is configured to compute beamformed channels by applying an appropriate time delay to each of the antenna signals.

9. The distributed beamforming system of claim 1, wherein the architecture is configured such that the power consumption required for data transfer between chiplets stays constant when additional chiplets configured as receivers and DBFLs are added.

10. A multi-stage, multi-path feed-forward (MSMPFF) compensated operational amplifier configured to reduce non-idealities, the MSMPFF amplifier comprising:
a main signal path comprising a first main gain stage transconductor configured to amplify an input signal;
a first chopper positioned before the input of the first main gain stage transconductor and configured to frequency-translate the input signal to a higher frequency band;
a de-chopper positioned after an output of the first main gain stage transconductor, configured to translate the amplified signal back toward a baseband frequency; and
a non-idealities reduction loop (NRL) configured to suppress non-ideality remains, the NRL comprising:
a non-idealities extraction circuit (NEC) configured to sense non-ideality remains present in the main signal path;
a feedback transconductor configured to generate a compensating current proportional to the sensed non-ideality remains; and
a current combining node configured to sum the compensating current with an output current of the first main gain stage transconductor to cancel or reduce the non-idealities.

11. The compensated operational amplifier system of claim 10, wherein the non-idealities reduced by the system predominantly include flicker noise and offset voltage.

12. The compensated operational amplifier system of claim 10, wherein the first chopper is configured to frequency-translate the input signal to a higher frequency band where the noise of the first main gain stage transconductor is negligible.

13. The compensated operational amplifier system of claim 10, wherein the frequency of the first chopper is selected such that the remaining non-idealities fall into the band of shaped quantization noise of an associated Sigma Delta modulator.

14. The compensated operational amplifier system of claim 10, wherein the NEC comprises a high pass filter, a second chopper, and a low pass filter configured in series to extract the non-ideality remains.

15. The compensated operational amplifier system of claim 10, wherein the NEC is implemented as a fully differential switched capacitor circuit.

16. The compensated operational amplifier system of claim 10, wherein the main signal path comprises transimpedance elements configured to convert current input to voltage output.

17. The compensated operational amplifier system of claim 10, wherein the MSMPFF amplifier is used as an operational amplifier within a continuous-time sigma delta analog-to-digital converter.

18. The compensated operational amplifier system of claim 10, wherein the NEC is configured to sense non-ideality remains present at an output node of a second main gain stage or a subsequent main gain stage.

19. The compensated operational amplifier system of claim 10, wherein the NRL uses a voltage amplifier configured to control body bias terminals of transistors implementing the first main gain stage transconductor to reduce the non-idealities.

20. A method for distributed beamforming in a system having a plurality of chiplets, the method comprising:
sampling antenna signals using a plurality of Analog-to-Digital Converters (ADCs);
distributing the sampled signals by broadcasting a digital bitstream corresponding to the sampled signals via a plurality of low power wireless short-range transmitters (WTXs), wherein the broadcasting is performed in an inherently broadcast manner such that a signal from one WTX may be received by any number of chiplets within range;
receiving the broadcast digital bitstreams from other chiplets via a plurality of low power wireless short-range receivers (WRXs); and
computing beamformed channels using Digital Beamforming Logic (DBFL), wherein the ADCs and the DBFL are distributed across the plurality of chiplets, and wherein the computing step utilizes at least the wirelessly received digital bitstreams from other chiplets.
